(19) United States
(12) Patent Application Publication
(10) Pub. No.: US 2013/0014041 A1
(43) Pub. Date: Jan. 10, 2013

(54) USING GESTURE OBJECTS TO REPLACE MENUS FOR COMPUTER CONTROL

(76) Inventor: Denny Jaeger, Lafayette, CA (US)

(21) Appl. No.: 13/447,980

(22) Filed: Apr. 16, 2012

Related U.S. Application Data
(63) Continuation-in-part of application No. 12/653,265, filed on Dec. 9, 2009, now abandoned.
(60) Provisional application No. 61/201,386, filed on Dec. 9, 2008.

(51) Int. Cl. G06F 3/048

(52) U.S. Cl. 715/765; 715/764

(57) ABSTRACT

The present invention generally comprises a computer control environment that builds on the Blackspace™ software system to provide further functionality and flexibility in directing a computer. It employs graphic inputs drawn by a user and known as gestures to replace and supplant the pop-up and pull-down menus known in the prior art.

### CROSS-REFERENCE TO RELATED APPLICATIONS

This application is a continuation-in-part of application Ser. No. 12/653,265, filed Dec. 9, 2009, which claims the priority date benefit of Provisional Aapplication No. 61/201,386, filed Dec. 9, 2008, both of which are incorporated herein by reference.

### FEDERALLY SPONSORED RESEARCH

Not applicable.

### SEQUENCE LISTING, ETC ON CD

Not applicable.

### BACKGROUND OF THE INVENTION

1. Field of the Invention

The invention relates generally to computer operating environments, and more particularly to a method for performing operations in a computer operating environment.

2. Description of Related Art

A newly introduced computer operating arrangement known as Blackspace™ has been created to enable computer users to direct a computer to perform according to graphic inputs made by a computer user. One aspect of Blackspace is generally described as a method for creating user-defined computer operations that involve drawing an arrow in response to user input and associating at least one graphic to the arrow to designate a transaction for the arrow. The transaction is designated for the arrow after analyzing the graphic object and the arrow to determine if the transaction is valid for the arrow. The following patents describe this system generally: U.S. Pat. No. 6,883,145, issued Apr. 19, 2005, titled Arrow Logic System for Creating and Operating Control Systems; U.S. Pat. No. 7,240,300, issued Jul. 3, 2007, titled Method for Creating User-Defined Computer Operations Using Arrows. These patents are incorporated herein by reference in their entireties. The present invention comprises improvements and applications of these system concepts.

### BRIEF SUMMARY OF THE INVENTION

The present invention generally comprises a computer control environment that builds on the Blackspace™ software system to provide further functionality and flexibility in directing a computer. It employs graphic inputs drawn by a user and known as gestures to replace and supplant the pop-up and pull-down menus known in the prior art.

### BRIEF DESCRIPTION OF THE DRAWING

FIG. 1 is a block diagram depicting a computer system capable of carrying out the operations of the present invention.

FIGS. 2 and 3 depicts typical menus that pull down or pop up that re IVDACC objects.

FIG. 4-15 illustrate various methods of the invention for combining a text object and picture object with text wrapped around the picture.

FIG. 16 is an illustration of rescaled and respaced text that may be used in a text wrap application.

FIG. 17 is a depiction of a VDACC object menu for borders that surround onscreen objects.

FIGS. 18-24A illustrate various methods of the invention for combining a text object and graphic object with text wrapped around the graphic.

FIGS. 25 and 26 illustrate methods of the invention for setting vertical margins of a text object without resorting to menu entries.

FIGS. 27-31 depict further methods for setting margins of a text object without using menu entries.

FIGS. 32-33 depict various methods of the invention for a primary object to own another onscreen object.

FIGS. 34-36 illustrates that videos may be primary objects that own other objects.

FIGS. 37-39 depict a further method for wrapping text about a picture, using free-drawn lines to define the wrap space.

FIG. 40 depicts some typical menu entries that may be replaced by the graphic gestures of the invention.

FIGS. 41-43 illustrate various methods of the invention for changing the grid without using any menu selection.

FIGS. 44-45 illustrate further methods for setting margins of text objects.

FIGS. 46-52 illustrate various methods of the invention for setting “snap-to” distances without using menu selections.

FIGS. 53 and 54 depict a further method for drawing to snap dissimilar object to each other.

FIG. 55 is a flow chart depicting the steps required to eliminate the prevent menus known in the prior art.

FIG. 56 depicts a “prevent” graphic, and FIGS. 57-60 illustrate some uses of the “prevent” graphic.

FIGS. 61 and 62 depict undo and redo graphics, and FIGS. 63-65 illustrate various uses of these graphics.

FIGS. 66-67 depict the use of an X graphic to delete objects or serve as a context object.

FIG. 68 illustrates a gesture method for “Place in VDACC object” without using any menu selection, and FIGS. 69-71 illustrate this gesture in various uses.

FIGS. 72-73 illustrate a method for using a tap and drag gesture to flip a graphic object.

FIG. 74 depicts the method in which a non-gesture object and a context are used to program another text object.

FIG. 75 depicts a table that may be used to associate a graphic gesture with a programming action.

FIGS. 76 and 77 depict various graphic gestures for changing the outline or fill color of a graphic object.

FIG. 78 illustrates a method for wrapping text to an edge without using a menu selection.

FIGS. 79-81 illustrate a gesture method of the invention for locking an object without resorting to a menu selection.

FIGS. 82-84 illustrate various methods for a user to draw a software-recognized object.

### DETAILED DESCRIPTION OF THE INVENTION

The present invention generally comprises various embodiments of the Gestures computer control environment that permit a user to have increased efficiency for operating a computer. The description of these embodiments utilizes the Blackspace environment for purposes of example and illustration only. These embodiments are not limited to the Blackspace environment. Indeed these embodiments have application to the operation of virtually any computer and computer environment and any software that is used to operate, control, direct, cause actions, functions, operations or the like, including for desktops, web pages, software applications, and the like.

Key areas of focus include:
1) Removing the need for text in menus, represented in Blackspace as IVDACC objects, which is an acronym for “Information VDACC object.” A VDACC is an acronym for “Virtual Display and Control Canvas.
2) Removing the need for menus altogether.

Regarding word processing: A VDACC object is an object found in Blackspace. As an object it can be used to manage other objects on one or more canvases. A VDACC object also has properties which enable it to display margins for text and perform word processing operations. In other software applications dedicated word processing windows are used for text. Many of the embodiments found herein can apply to both VDACC object type word processing and windows type word processing. Subsequent sections in this application include embodiments that permit users to program computers via graphical means, verbal means, drag and drop means, and gesture means. There are two considerations regarding menus: (1) Removing the need for language in menus, and (2) removing the need for menu entries entirely. Regarding VDACC objects and IVDACC objects, see “Intuitive Graphic User Interface with Universal Tools,” Pub. No.: US 2005/0034083, Pub. Date: Feb. 10, 2005, incorporated herein by reference.

This invention includes various embodiments that fall into both categories. The result of the designs described below is to greatly reduce the number of menu entries and menus required to operate a computer and at the same time to increase the speed and efficiency of its operation. The operations, functions, applications, methods, actions, performance, process, enactments, changes, including changes in any state, status, behavior and/or property and the like described herein apply to all software and to all computer environments. These terms are referred to in this disclosure by many terms, including: transaction, action, function, etc. Blackspace is used as an example only. The embodiments described herein employ the following: drawing input, verbal (vocal) input, new uses of graphics, all picture types (including GIF animations), video, gestures, 3-D and user-defined recognized objects. User inputs include any via input to a computer system, including one or more of the following: gesture in the air, a drawing on a digital canvas or touch screen, a computer generated input, an input to a holographic display and the like.

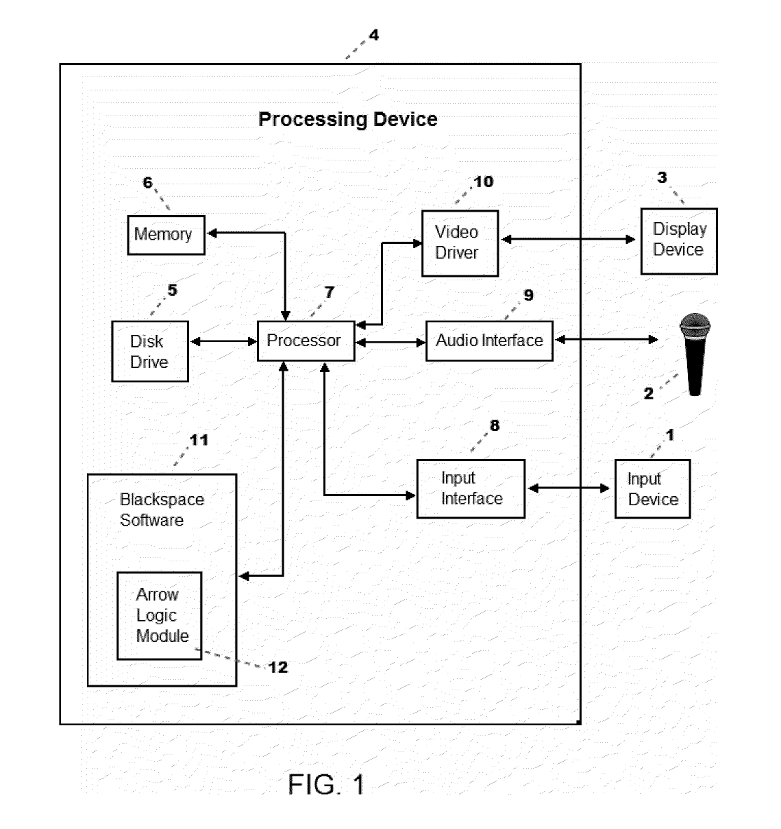

As illustrated in FIG. 1, the computer system for providing the computer environment in which the invention operates includes an input device 1, a microphone 2, a display device 3 and a processing device 4. Although these devices are shown as separate devices, two or more of these devices may be integrated together. The input device 1 allows a user to input commands into the system to, for example, draw and manipulate one or more arrows. In an embodiment, the input device 1 includes a computer keyboard and a computer mouse. However, the input device 1 may be any type of electronic input device, such as buttons, dials, levers and/or switches on the processing device 4. Alternatively, the input device 1 may be part of the display device 3 as a touch-sensitive display that allows a user to input commands using a finger, a stylus or devices. The microphone 2 is used to input voice commands into the computer system. The display device 3 may be any type of a display device, such as those commonly found in personal computer systems, e.g., CRT monitors or LCD monitors.

The processing device 4 of the computer system includes a disk drive 5, memory 6, a processor 7, an input interface 8, an audio interface 9 and a video driver 10. The processing device 4 further includes a Blackspace User Interface System (UIS) 11, which includes an arrow logic module 12. The Blackspace UIS provides the computer operating environment in which arrow logics are used. The arrow logic module 12 performs operations associated with arrow logic as described herein. In an embodiment, the arrow logic module 12 is implemented as software. However, the arrow logic module 12 may be implemented in any combination of hardware, firmware and/or software.

The disk drive 5, the memory 6, the processor 7, the input interface 8, the audio interface 9 and the video driver 10 are components that are commonly found in personal computers. The disk drive 5 provides a means to input data and to install programs into the system from an external computer readable storage medium. As an example, the disk drive 5 may a CD drive to read data contained therein. The memory 6 is a storage medium to store various data utilized by the computer system. The memory may be a hard disk drive, read-only memory (ROM) or other forms of memory. The processor 7 may be any type of digital signal processor that can run the Blackspace software 11, including the arrow logic module 12. The input interface 8 provides an interface between the processor 7 and the input device 1. The audio interface 9 provides an interface between the processor 7 and the microphone 2 so that use can input audio or vocal commands. The video driver 10 drives the display device 3. In order to simplify the figure, additional components that are commonly found in a processing device of a personal computer system are not shown or described.

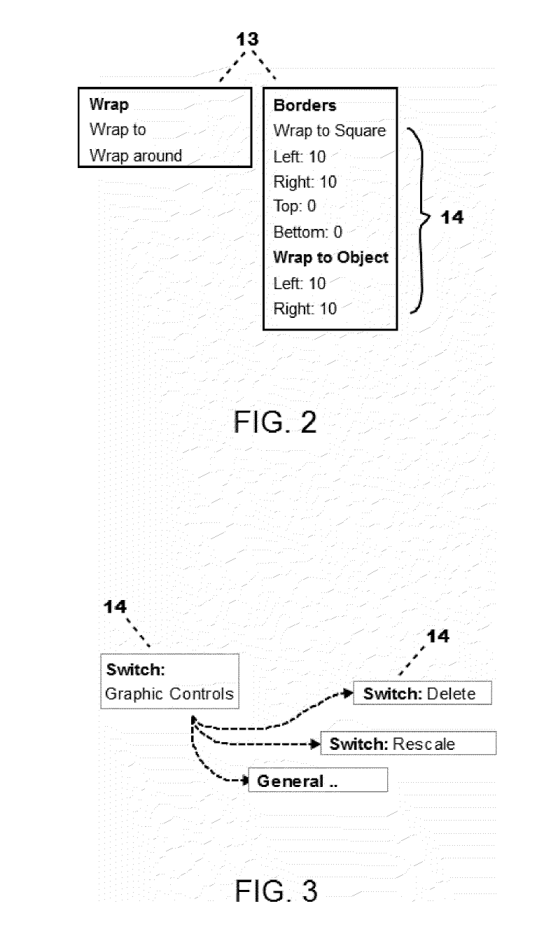

FIG. 2 illustrates typical menus 13 that pull down or pop up, these menus being comprised of IVDACC objects 14. An IVDACC object is a small VDACC object (Visual Display and Design Canvas) that comprises an element of an Info Canvas. An Info Canvas 13 is made up of a group of IVDACC objects which contain one or more entries used for programming objects. It is these types of menus and/or menu entries and any other type of menu entry that this invention replaces with graphic gesture entries for the user, as shown in FIGS. 2 and 3.

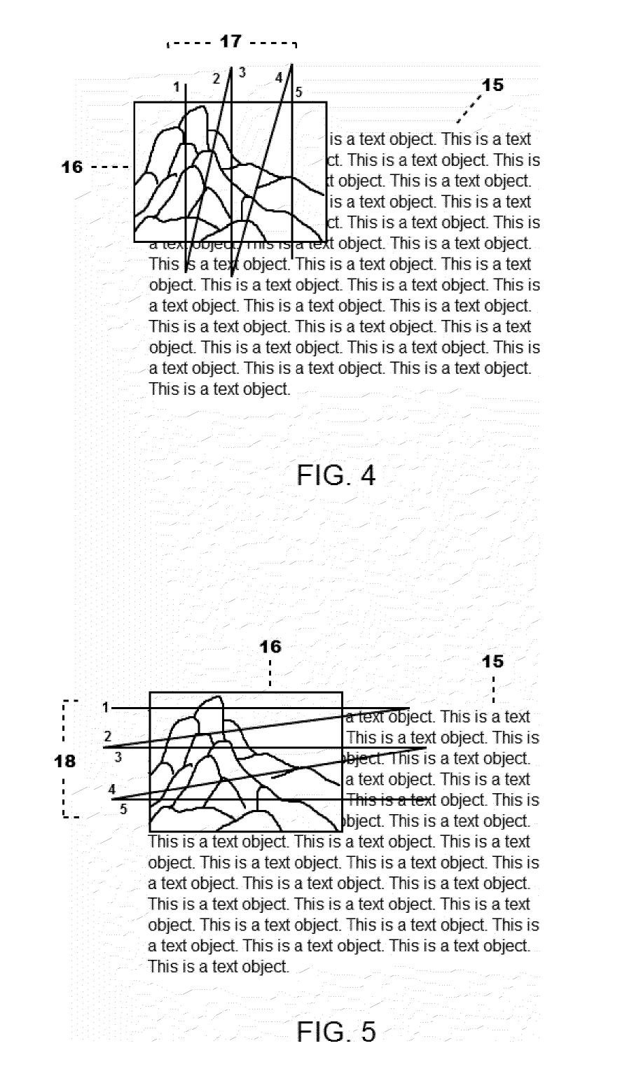

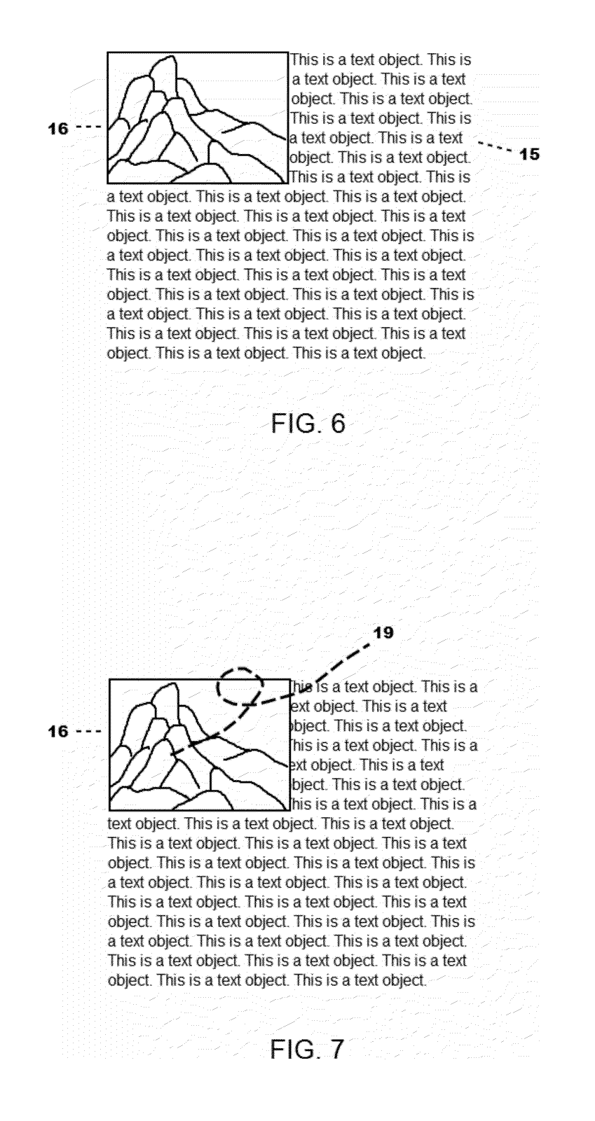

FIG. 4 illustrates a text object 15 upon which is placed a picture 16, the goal being to perform text wrap around the picture without using a menu. The method illustrated in FIG. 4 removes the need for the “Wrap” sub-category and “wrap to” and “Wrap around” entries. After the picture 16 is placed over the text 15, the user shakes the picture 16 up and down 17 five times in a “scribble type” gesture, or shakes the picture left to right 18 five times in a “scribble type” gesture (FIG. 5) to command the text wrap function, resulting in a text wrap layout as shown in FIG. 6. The motion gesture of “shaking” the picture invokes the “wrap” function and therefore there is no need for the IVDACC object entry “wrap around.” When there is a mouse up click (release the mouse button after shaking the picture or lifting up a pen or finger) the picture is programmed with “text wrap”. This action is recognized by software as a defined by a context, thus it is as though the user just selected “wraparound” under the sub-category “Wrap”.

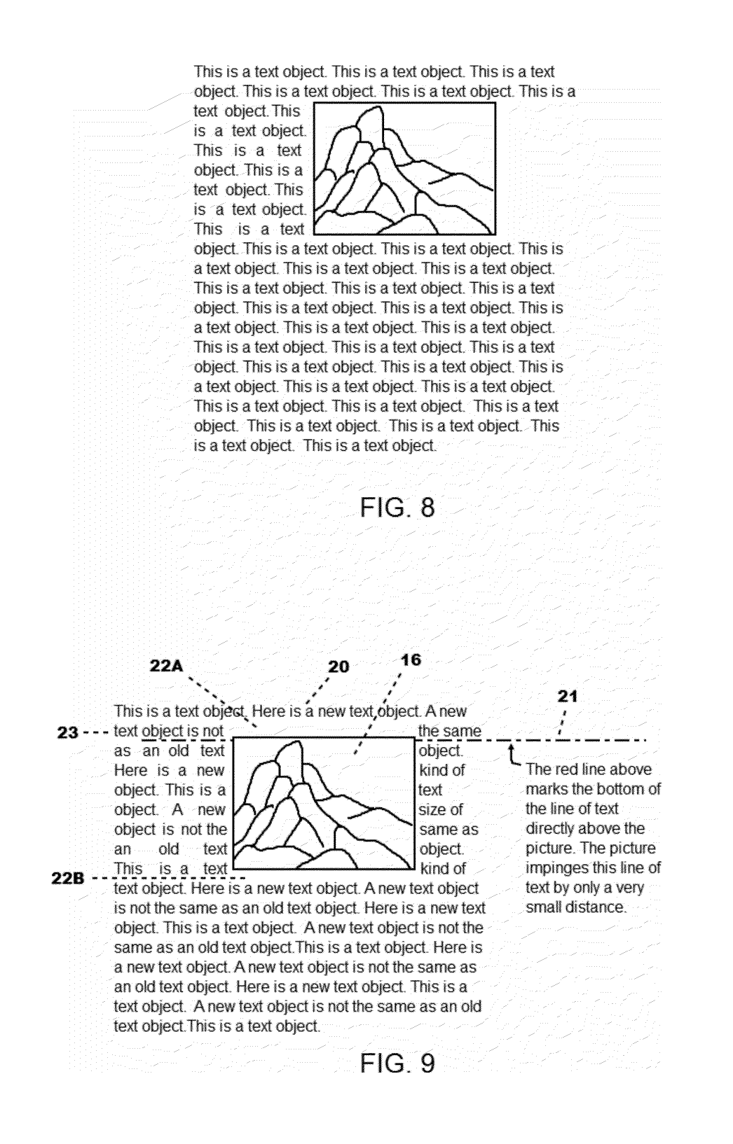

FIG. 7 illustrates removing text wrap for an object with text wrap engaged. This embodiment uses a “gesture drag” 19 to turn off “wrap around”, “wrap to” and the like for an object 16. The path of the gesture drag 19 is shown as a dashed line. A user drags an object that has wrap turned “on” along a specific path 19—which can be any recognizable shape. Dragging an object, like a picture 16, for which text wrap is “on” in this manner would turn “off” text wrap for that object. Thus dragging the picture along the single looped path 19, shown by the dashed line of FIG. 7, causes “wrap” to be turned off for the picture 16. “Shake” the picture again, as described above, and “wrap” will be turned back on (FIG. 8). Any drag path (also known as motion gesture) that is recognized by software as designating the text wrap function to be turned off can be programmed into the system.

FIG. 9 illustrates a method for Removing the “Wrap to Object” sub-category and menus. First, “wrap” has only two border settings, a left and a right border. The upper and lower borders are controlled by the leading of the text itself. Notice the text 20 wrapped around the picture 16 in FIG. 9: there is more space above the picture than below it. This is because the picture just barely intersects the lower edge 21 of the line of text above it. But this intersection causes the line of text to wrap to either side of the picture. This is not desirable, as it leaves a larger space above the picture than below.

One solution is to rescale the picture's top edge just enough so the single line of text above the picture does not wrap. A far better solution would be for the software to accomplish this automatically. One way to do this is for the software to analyze the vertical space above 22A and below 22B any object wrapped in text. If a space, like what is shown in FIG. 9, is produced, namely, the object just barely impinges the lower edge of a line of text, then the software would automatically adjust the vertical height of the object to a position that does not cause the line of text to wrap around the object. A user-adjustable maximum distance could be used to determine when the software would engage this function. For instance if a picture 16 (wrapped in atext object 20) impinges the line of text above it by less than 15%, this software feature would be automatically engaged. The height of the picture 16 would be reduced and the line of text 23 directly above the picture would no longer wrap around the picture.

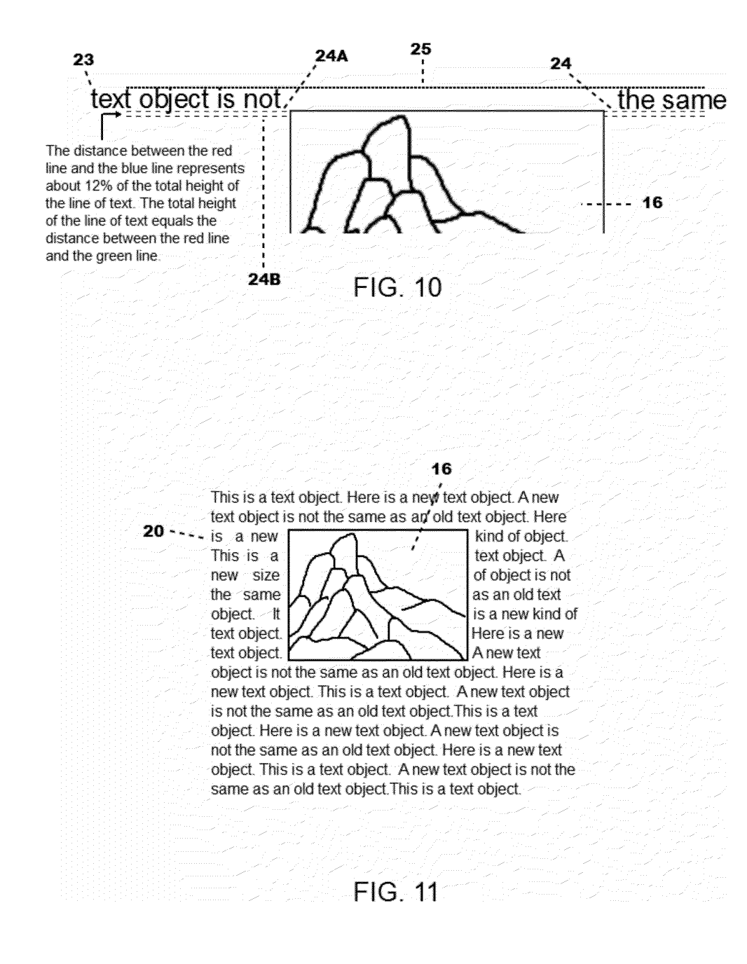

FIG. 10 shows the picture 16 and the line of text 23 intersected by the picture 16 from the previous example. They have been increased in size for easier viewing. The top thin dashed line 24A indicates the lower edge of the line of text 23 directly above the picture 16. The picture 16 impinges this text 23 by a very small distance. This distance can be represented as a percentage of the total height of the line of text. A dotted line 25 shows the top edge of the line of text 23. The top thin dashed line 24A has been drawn along the top edge of the picture 16. The distance between the dashed lines 24A and 24B equals the amount that the picture is impinging the line of text 23. This can be represented as a percentage of the total height of the line of text, which is about 12%. Note: the height of the text equals the distance between the line 25 and the line 24A. This percent can be used by the software to determine when it will automatically rescale a graphical object that is wrapped in a text object to prevent that graphical object from causing a line of text to wrap when the graphical object only impinges that line of text by a certain percentage. This percentage can be user-determined in a menu or the like. The picture 16 (from FIG. 9) has been adjusted in height by software to create an even upper and lower boundary between the picture 16 and the text 20 in which it is wrapped, is shown in FIG. 11.

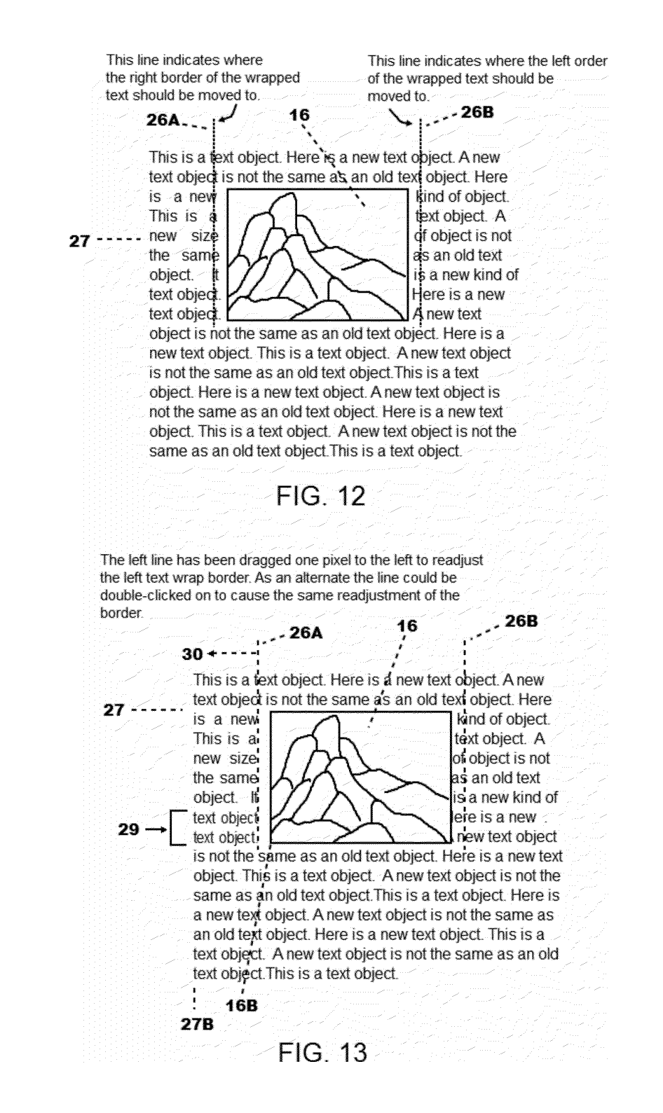

FIGS. 12 and 13 illustrate replacing the “left 10” and “right 10” entries for “Wrap.” Draw a vertical line 26 of any color to the right and/or left of a picture 16 that is wrapped in a text object 27. These one or more lines will be automatically interpreted by the software as border distances. The contexts enabling this interpretation is:
(1) Drawing a vertical line (preferably drawn as a perfectly straight line—but the software should be able to interpret a hand drawn line that is reasonably straight—like what you would draw to create a fader).
(2) Having the drawn line intersect text that is wrapped around at least one object or having the drawn line be within a certain number of pixels from such an object.
   Note: (3) below is optional.
(3) Having the line be of a certain color. This may not be necessary. It could be determined that any color line drawn in the above two described contexts will comprise a reliably recognizable context. The use of a specific color (i.e., one of the 34 Onscreen Inkwell colors) is that this would distinguish a “border distance” line from just a purely graphical line drawn for some other purpose along side a picture wrapped in text. Once the line (i.e., the line 26) is drawn and an up-click or its equivalent is performed, the software will recognize the line as a programming tool and the text (i.e., the text object 27) that is wrapped on the side of the picture (i.e. the picture 16) where the line (i.e., the line 26) was drawn will move its wrap to the location marked by the line. As an alternate a user action could be required, for example, dragging the line at least one pixel or double-clicking on the line in enable the text to be rewrapped by the software.

FIG. 12 shows two dashed vertical lines 26A and 26B drawn over a text object 27. The line 26A to the left of the picture indicates where the right border of the wrapped text should be. The line 26B to the right of the picture indicates where the left border of the wrapped text should be. In FIG. 13, a user action is required to invoke the rewrapping of text. This is accomplished by either dragging one of the vertical dashed lines or by double-clicking on it. Once the software recognizes the drawn vertical lines as tools, the lines can be clicked on (or touched by a finger or pen) and dragged to the right or left or up or down.

Referring again to FIG. 13, the line 26A has been dragged one pixel. This has cause the text to the left of the picture 16 to be rewrapped. Notice the two lines of text 29 to the left of the picture 16. They both read “text object.” This is another embodiment of this software. When the text wrap was readjusted by dragging line 26A at least one pixel 30 to the left of the picture 16, this caused a problem with these two lines 29. The words “text object” do not fit in the smaller space that was created between the left text margin 27B and the left edge of the picture 16B. So these two phrases 29 were automatically rescaled to fit the allotted space. In other words, the characters themselves and the spaces between the characters were horizontally rescaled to enable this text to look even but still fit into a smaller space.

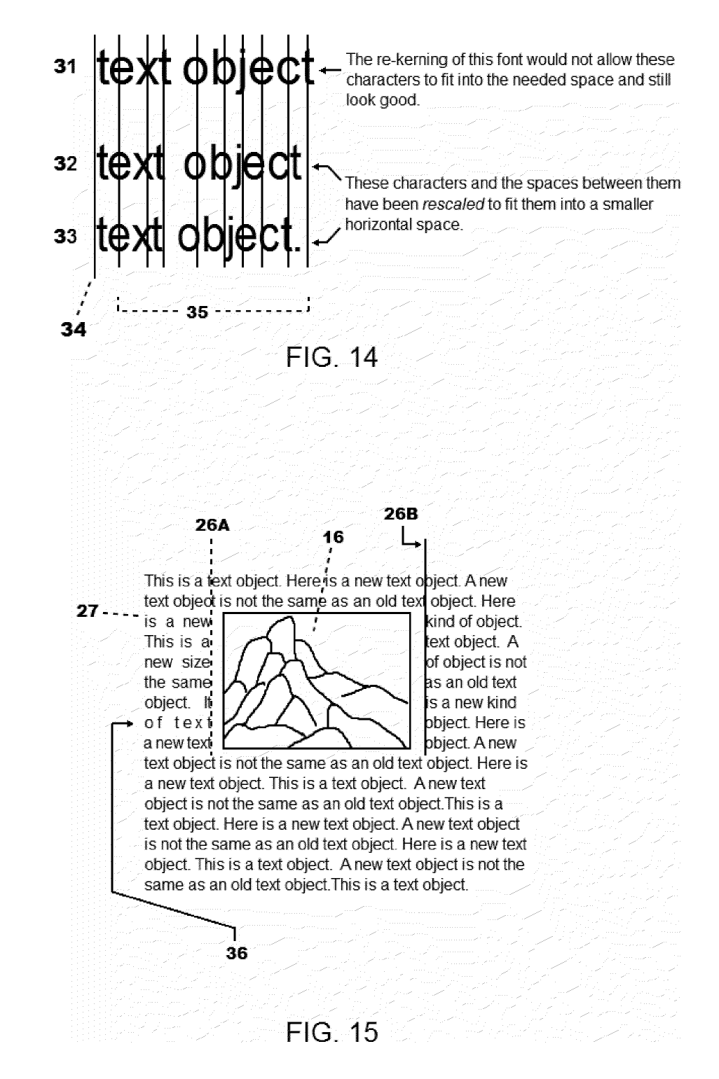

FIG. 14 is a more detailed comparison between the original text “31” and the rescaled text, “32” and “33”. The vertical line 34 marks the leftmost edge of the text. The vertical lines 35 extend through the center of each character in the original text and then extend downward through both rescaled versions of the same text. Both the individual characters and the spaces between the characters for “32” and “33” have been rescaled by the software to keep the characters looking even, but still fitting them into a smaller horizontal space. Note: the rescaling of the text as explained above could be the result of a user input. For instance, if the left 26A or right vertical line 26B were moved to readjust the text wrap, some item could appear requiring a user input, like a click, touch, gesture or verbal utterance or the like.

FIG. 15 shows the result of activating the right vertical line 26B to cause the rewrap of the text 27 to the right of the picture 16. This represents a new “border” distance. Notice the characters “of text” 36. These characters have been adjusted. Using the unadjusted characters “of text” 36 here would leave either a large space between the two words: “of text” or leave a large space between the end of the word “text” and the left edge of the picture 16. Neither is a desirable solution to achieving good looking text.

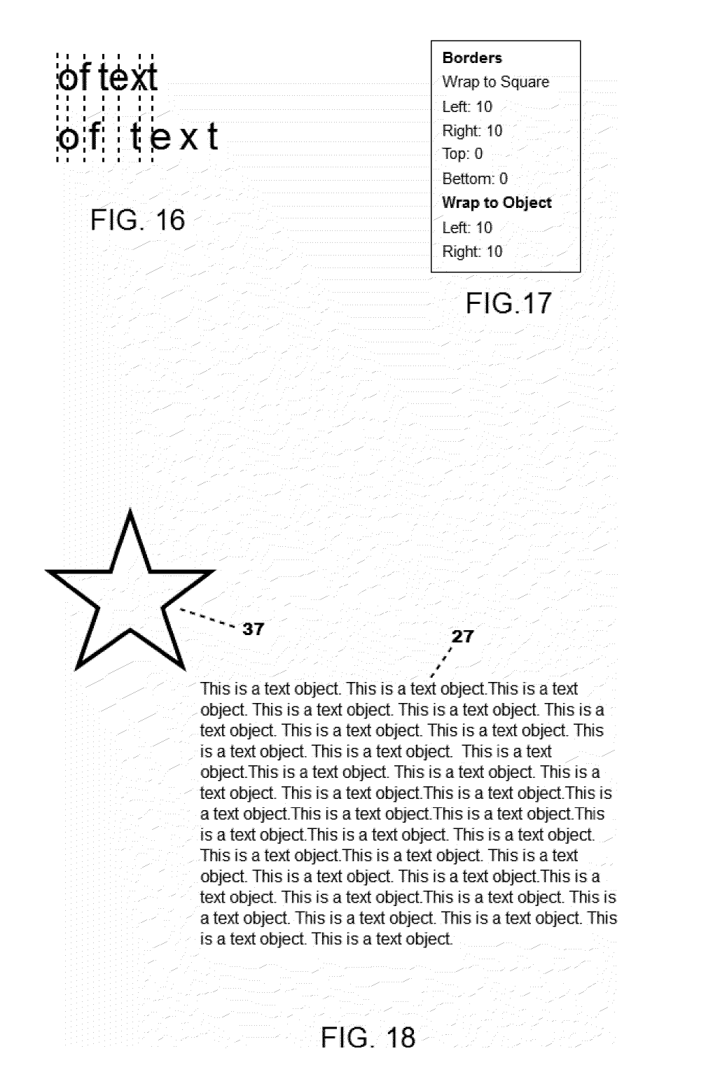

To fix this problem the software automatically (or by user input) rescales these words by elongating each individual character and increasing the space between the text (the kerning). One benefit to this solution is that the increase in kerning is not done according to a set percentage. Instead it is done according to the individual widths of the characters. So the rescaling of the spaces between these characters can be non linear. In addition, the software maintains the same weight of the text such that it matches the text around it. When text is rescaled wider, it usually increases in weight (the line thickness of the text increases). This makes the text appear bulkier and it no longer matches the text around it. This is taken into account by the software when it rescales text and as part of the rescaling process the line thickness of the rescaled text remains the same as the original text in the rest of the text object. Referring now to FIG. 16, this illustrates a text object that has been elongated without changing the weight of the text characters and according to a non-linear scheme of adjusted horizontal spacing between the text characters.

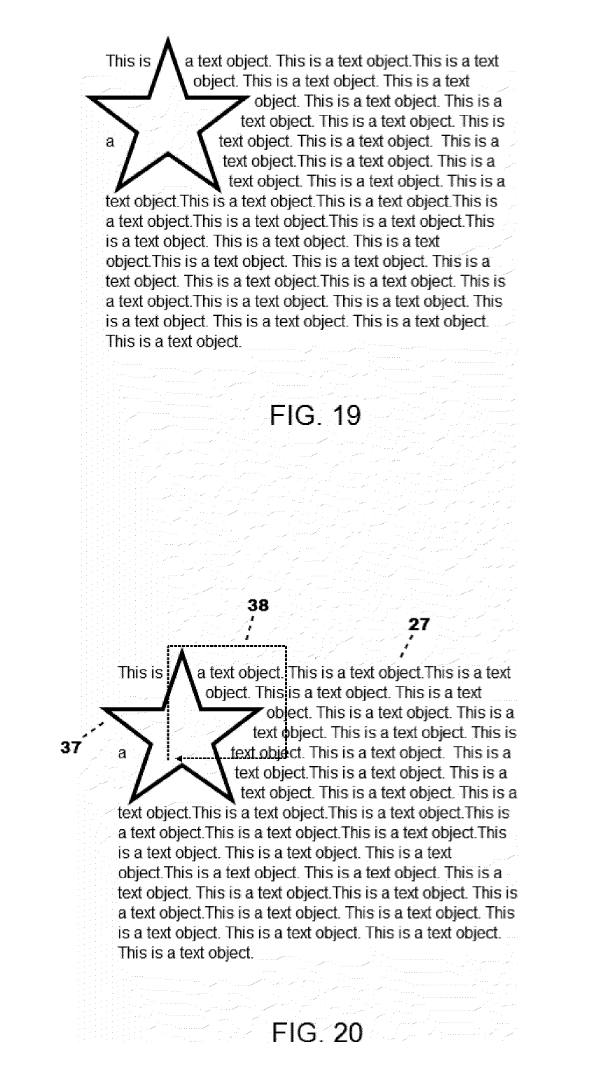

With regard to FIG. 17, the VDACC object menu “Borders” is shown, and the following examples illustrate techniques that eliminate at least four menu items and replace them with gesture equivalents. Consider the star 38 and text object 27 of FIG. 18, and place the star in the text object 27 with text wrap by shaking the star up and down 5 times, resulting in the text wrapped layout of FIG. 19. Notice that this is not a very good text wrap. Since the star has uneven sides the text wrap is not easily anticipated or controlled with a simple “wrap around” type text wrap. One remedy to this problem is “Wrap to Square.” This places an invisible bounding rectangle around the star object and wraps the text to that bounding rectangle.

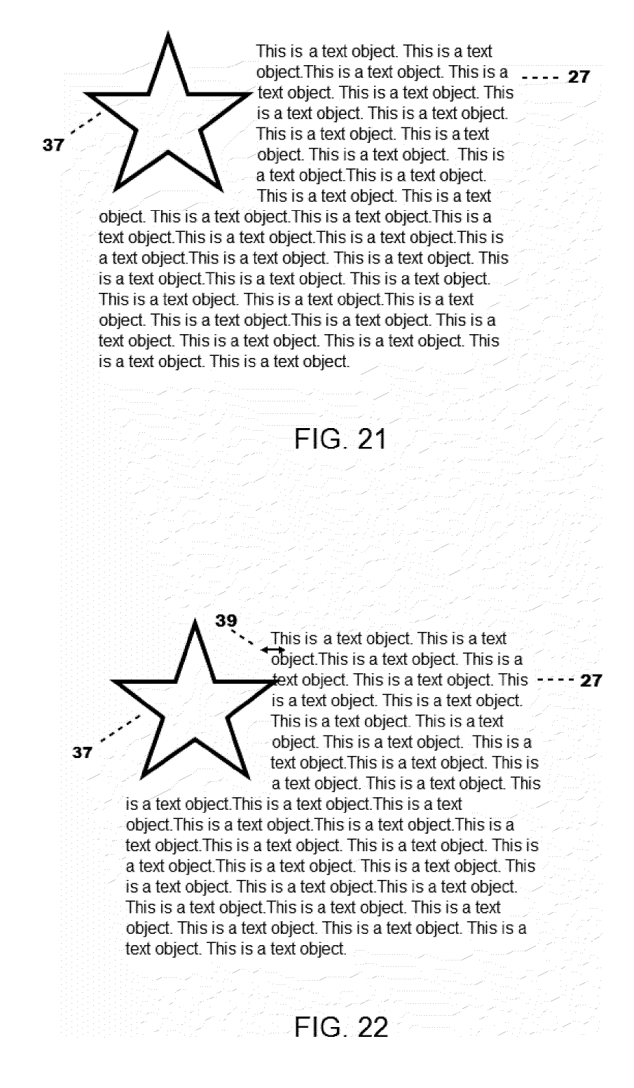

Referring to FIG. 20, to accomplish this without resorting to menu entries, drag the object 37 (for which “wrap to square” is desired) in a rectangular motion gesture (drag path), shown by the rectangular arrow with a dotted shaft 38, over the text object 27. The gesture can be started on any side of a rectangle or square. If one is making the gesture with a mouse, it would left click and drag the star in the shape shown above. If using a pen, one could push down the tip of the pen (or a finger) on the star and drag it in the shape shown in FIG. 20. When one does a mouse up-click, or its equivalent, the text will be wrapped to a square around the object that was dragged in the clockwise rectangular pattern over a text object. The result of this rectangular gesture is shown in FIG. 21. The object 37 has been “wrapped to square” in text 27.

NOTE: When one drags an object, in this case a star 37, in a rectangular gesture 38, the ending position for the “wrapped to square” object is the original position of said object as it was wrapped in the text before it was dragged to create the “wrap to square” gesture. NOTE: the rectangular drag could start on any vertex of a rectangular shape and move in any direction to cause a transaction.

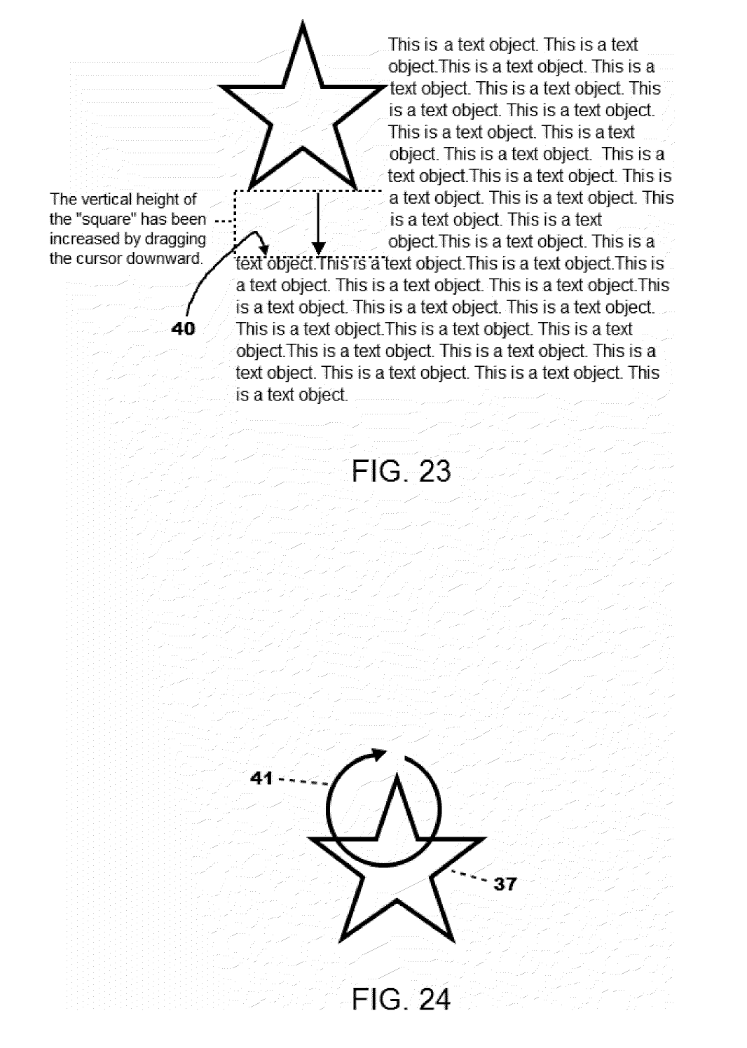

FIG. 22 illustrates a method to modify the shape of the “square.” Float the mouse cursor over any of the four edges of the “invisible” square. Since the wrapped star 37 of FIG. 22 only has text on two sides, one would float over (or its equivalent) either the right or bottom edge of the “square” (also referred to as the “wrap square”) and the cursor (or its equivalent) will turn into a double arrow 39 or its equivalent. Then a touch would be made on the edge of the invisible “wrap square” and a drag would be performed to change the shape of the “square.” FIG. 23 shows a method to adjust the height of the wrap square of FIG. 22 by clicking on (touching) the wrap border and then dragging down to line increase its height.

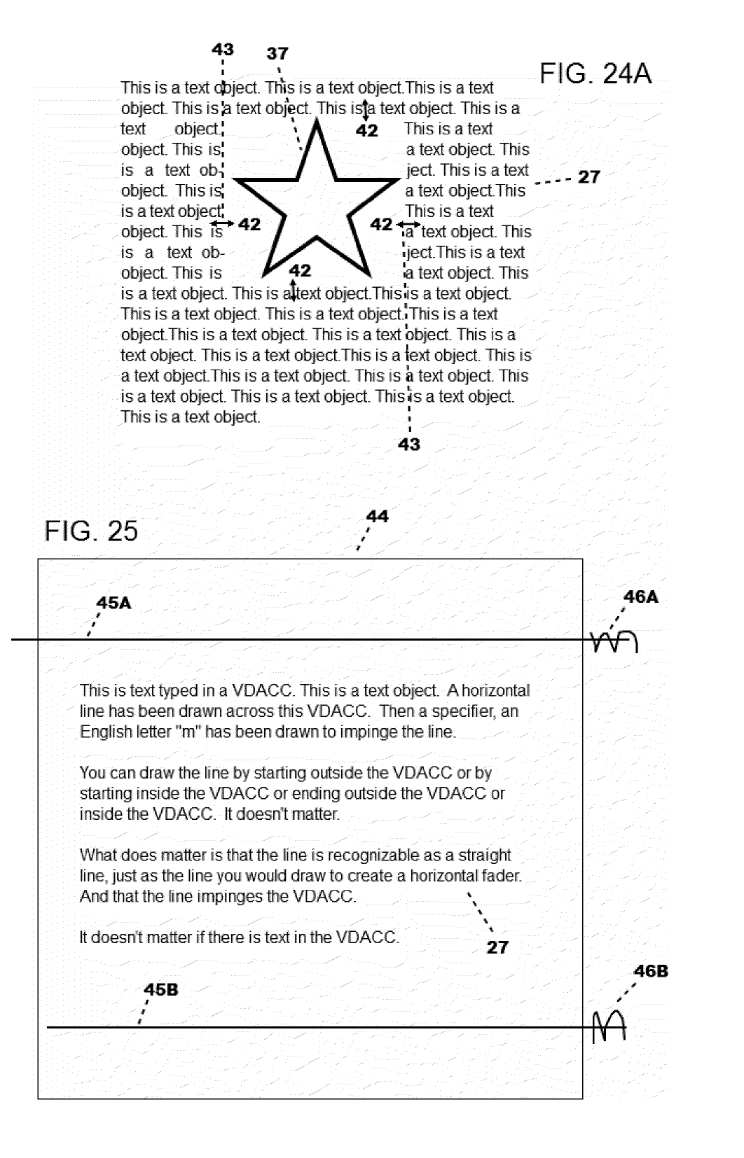

FIG. 24 illustrates a method to display what the exact values of the wrap square edges are. Below are listed some of the ways of achieving this.
(1) Use a circular arrow gesture 41 of FIG. 24 over the star graphic 37 to “show” or “hide” the parameters or other objects or tools associated with the star graphic. Draw a circular shape arrow or line over the star object. When the arrow (line) is activated the tools, parameters, other objects, etc. associated with the text wrap for the star object will appear if they are currently hidden or be hidden if they are currently visible.
(2) Use a verbal command, i.e., “show border values”, “show values”, etc.
(3) Double click on the star graphic to toggle the parameters on and off.
(4) Use a traditional menu (Info Canvas) with the four Wrap to Square entries—but this traditional menu structure is what this invention eliminates.
(5) Click on the star graphic and then push a key to toggle between “show” and “hide.”
(6) Float the mouse over any edge of the wrap square and a pop up tool tip appears showing the value that is set for that edge.

FIG. 24A is the same star 37 as shown in the above examples now placed in the middle of a text object 27. In this case one can float over (or its equivalent) any of the four sides of the wrap area and get a double arrow cursor (or its equivalent) and then drag to change the position of that side (text wrap border). Dragging on the edge of a wrap border or on a double arrow cursor 42 (or its equivalent) in any direction changes the position of the text wrap around the star 37 on that side.

The following examples illustrate eliminating the need for vertical margin menu entries. Vertical margin menu entries can be removed by the following means. Use any line or use a gesture line that invokes “margins,” which could be selected from a “personal objects toolbox.” This could be a line with a special color or line style or both. Using this line, draw a horizontal line that impinges a VDACC object or wordprocessor environment.

Alternatively, draw a horizontal line that is above or below or that impinges a text object that is not in a VDACC object. Note: objects that are not in VDACC objects are in Primary Blackspace. In either case, a simple line can be drawn. Then type or draw a specifier graphic, i.e., the letter “m” for margin. Either draw this specifier graphic directly over the drawn line or drag the specifier object to intersect the line. If a gesture line that invokes margins is used (whose action is “invoke margins”), then no specifier would be needed. Determine if a second drawn horizontal line is above or below a first drawn horizontal line. This determination is to decide if a drawn horizontal line is the top or bottom margin for a given page of text or text object. There are many ways to this; for example, if there is only one drawn horizontal line, then that could be determined to be the top margin if it is above a point that equals 50% of the height of the page or the height of the text object not in a VDACC object. And it will be determined to be a bottom margin if it is below a point that equals 50% of the height of a page or the height of a text object not in a VDACC object. If there is no page then it will be measured according to the text object's height.

If it is desired to have a top margin that is below this 50% point, then a more specific specifier will be needed for the drawn line. An example would be “tm” for “top margin,” rather than just “m.” Or “bm” or “btm” for bottom margin, etc. Note: The above described items would apply to one or more lines drawn to determine clipping regions for a text object.

FIG. 25 illustrates a VDACC object 44 with a text object 27 in it. A horizontal line 45A is drawn above the text object and impinged with a specifier “m” 46A. This becomes the top vertical margin for this VDACC object 44. Lower on the VDACC object a second horizontal line 45B is drawn and impinged with a specifier 46B. This becomes the lower margin. Note: The text that exists in the following examples is informative text and serves in most cases to convey important information about the embodiments herein.

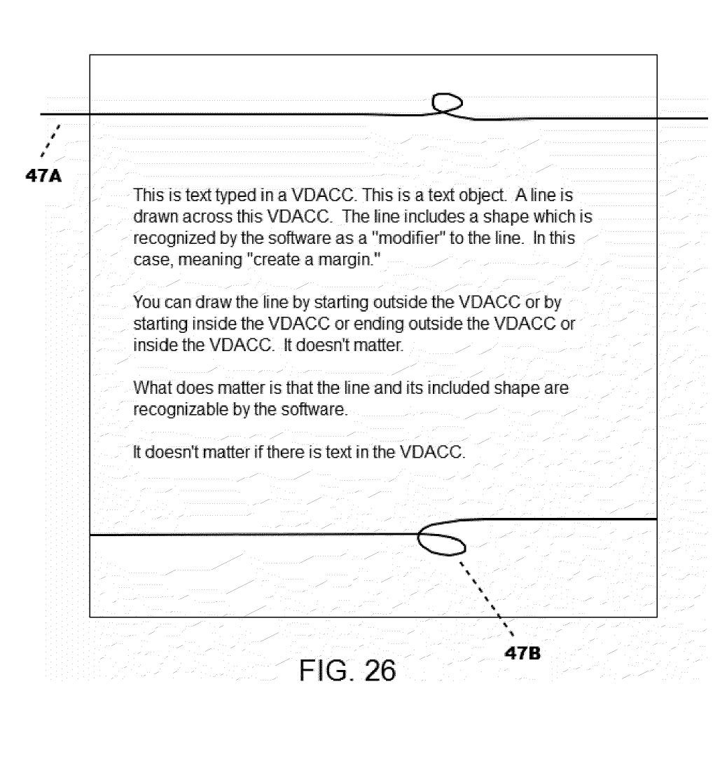

With regard to FIG. 26 instead of drawing a line and then modifying that line by impinging it with a specifier, the line and specifier are drawn as a single stroke. In the example below, a loop has been included as part of a drawn line 47A to indicate “margin.” Note: any gesture or object could be used as part of the line as long as it is recognizable by software. In this example the upward loop in the line 47A indicates a top margin and the downward loop in line 47B indicates a bottom margin.

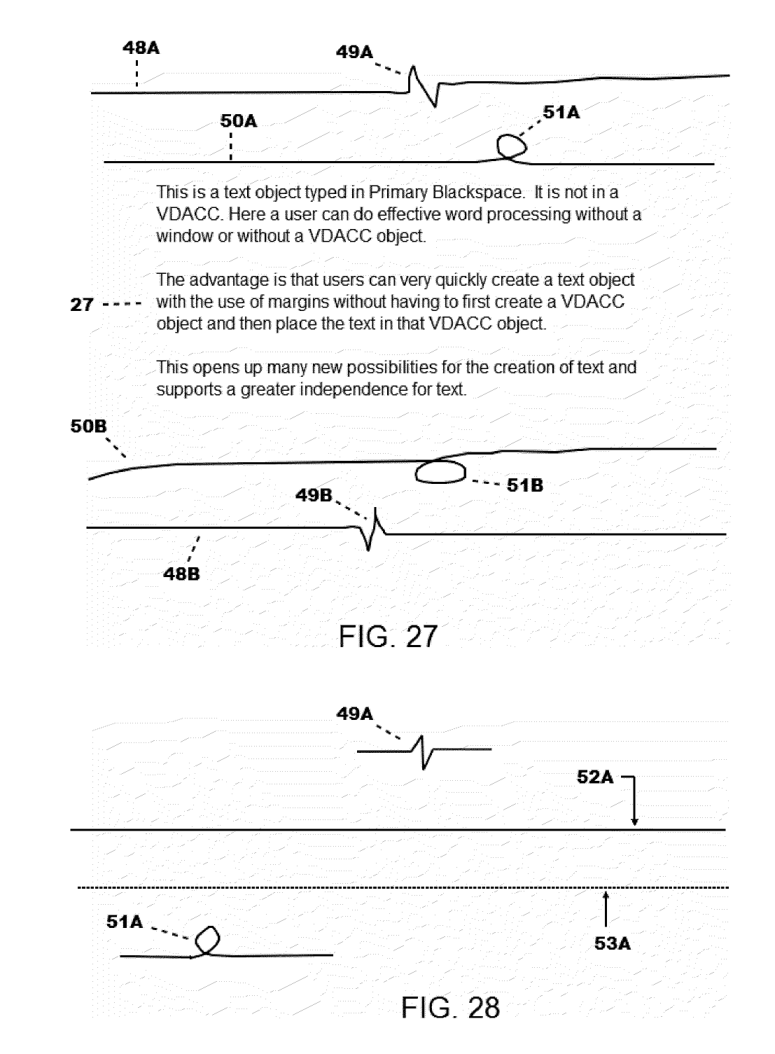

FIG. 27-28 shows a text object presented in Primary Blackspace (free space) with hand drawn margins. Referring first to FIG. 27, a top line 48A is drawn with a definable zigzag shape 49A in the line. This shape denotes a function for the drawn line. In the case of this example, the zigzag shape 49A causes the line to function as an upper clipping region for a text object 27. Referring again to FIG. 27, a second line 50A is drawn above text object 27 and under line clipping region line 48A. This second line 50A is drawn with a loop shape 51A in it. This loop shape 51A is recognized by the computer and enables the drawn line 50A to become the upper horizontal margin for the text object 27. Line 50B with a loop 51B has been drawn below the text object 27 to create a lower horizontal margin for the text. Line 48B with a zigzag 49B has been drawn below the text to create a lower clipping region for the text object.

Referring again to FIG. 27, shapes like the zig zag shape 49A and 49B in the lines 48A and 48B or the loop 51A and 51B in the lines 50A and 50B can be programmed as gesture objects. Then these gesture objects can be employed in the drawing of a line such that when the software recognizes the gesture object, it applies the function or action of said gesture object to the drawn line and thereby defines a function or action or the like for the line, which can be applied to an object.

Referring to FIG. 28, the drawn top line 48A of FIG. 27, containing the zigzag 49A, has been recognized by the software and has been turned into a computer generated line 52A. This top line 52A becomes an upper clipping boundary. NOTE: shapes draw as part of a line stroke can also be equivalents for known actions, functions, operations, protocols, behaviors, processes, statuses, conditions, orders, states, properties and the like. Referring again to FIG. 28, the second drawn line 50A of FIG. 27 containing a loop 51A has been recognized by the software and turned into a computer generated line 53A.

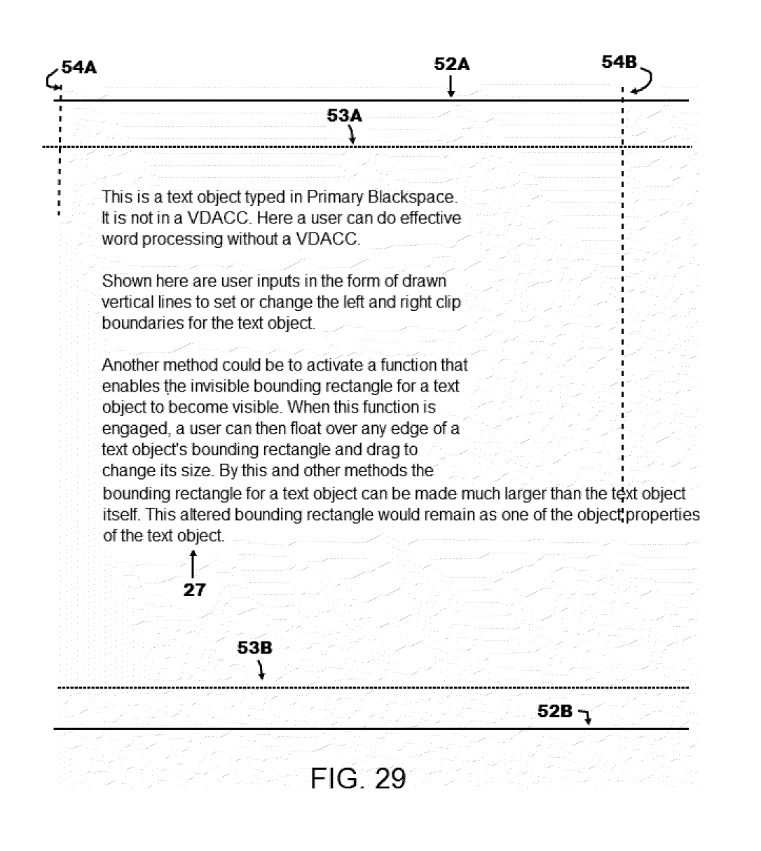

Referring to FIG. 29, the top and bottom zigzag lines 48A and 48B of FIG. 27 have been recognized by the computer and have become the top and bottom clipping regions 52A and 52B for the text object 27 in between them. Also the top and bottom lines 50A and 50B of FIG. 27 containing a loop have been recognized by the computer and have become the top and bottom margin lines 53A and 53B for the text object 27. Also in FIG. 29, right and left margin lines 54A and 54B have been drawn for text object 27. Notice that line 54B intersects text object 27.

The text object of FIG. 29 has been created in Primary Blackspace. It is not in a VDACC object. This is a change in how text processing works. Here a user can do effective word processing without a VDACC object or a window. The advantage is that users can very quickly create a text object and apply functions, actions, conditions, operations, tools and the like (i.e. margins) to that text object without having to first create a VDACC object and then place text in that VDACC object or without having to utilize a computer word processing program that 20 operates in a window. This opens up many new possibilities for the creation of text and supports a greater independence for text objects. The advantage is that a user can create a text object by typing or otherwise entering text onscreen and then, by drawing lines in association with that text object, can operate that text object. The association of drawn lines with a text object can be by spatial distance, e.g., default distance saved in software, or a user defined distance, by intersection with the bounding rectangle for a text object whose size is user-definable and the like. So as one example of the result of user inputs, the size of the invisible bounding rectangle around a text object can be altered. This input could be by dragging, drawing, verbal and the like. In addition to the placement of margins, clip regions can become part of a text object's properties. These clip regions would also enable the scrolling of a text object inside its own clip regions, which are a part of the text object.

Creating margins for a text object in Primary Blackspace or its equivalent can be done with single stroke lines. The loop in the drawn line of FIG. 27 designates “margin”. In FIG. 27 a line 50A containing an upper loop was drawn and in FIG. 29 that line and its gesture loop were recognized by the software and then computer rendered as a top margin 53A. Furthermore, in FIG. 29 the line of FIG. 27 containing a bottom loop 51B was drawn and recognized by the software and rendered as a bottom margin line 53B. Again, FIG. 29 shows a text object typed in Primary Blackspace. It is not in a VDACC object or part of a word processor. Here in free space a user can do effective word processing without a window or VDACC object to manage objects in free space.

A “shape” used in a line determines the action of the line. Thus the recognition of lines by the software is facilitated by using shapes or gestures in the lines that are recognizable by the software. In addition, these gestures can be programmed by a user to look and work in a manner desirable to the user.

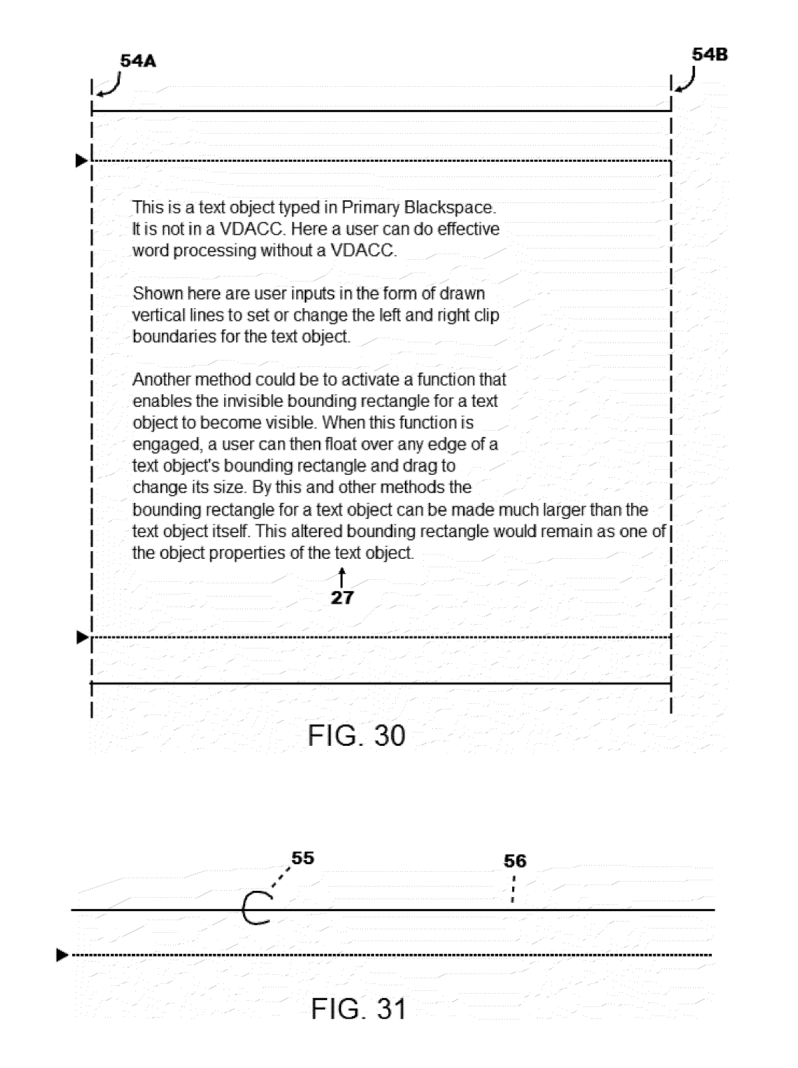

FIG. 30 further illustrates setting the width of a text object by drawing. Users can draw vertical lines that impinge a clip region line belonging to (e.g., that is part of the object properties of) a text object. These drawn vertical lines can become horizontal clip region boundaries for this text object and as such, they would be added to or updated as part of the object properties of the text object. These drawn vertical lines are shown in FIG. 30 as lines 54A and 54B. FIG. 30 illustrates the result of the vertical lines 54A and 54B drawn in FIG. 29. The drawing of line 54B has caused the text object 27 to wrap. These new regions are updated as part of the properties of the text object 27. The programming of vertical margins could be the same as described herein for horizontal margins.

FIG. 31 depicts a gesture technique for creating a clip region for a text object by modifying a line with a graphic. A “C” 55 is drawn to impinge a line 56 that has been drawn above and/or below a text object for the purpose of creating an upper and lower clip region for the text object. This is an alternate to the single stroke approach described above. The use of the “C” 55 modifier enables a line 56 to be free drawn above text that is freely typed onscreen outside a window or VDACC object. Thus text objects can be presented in Primary Blackspace (free computer space) and programmed with margin lines. This “C” 55 could be the equivalent of any action, in this example, it is the action “clip” or “establish a clip region boundary.”

The drawing of a recognized modifier object, like the “C” in this example, turns a simple line style into a programming line, like a “gesture line.” The software recognizes the drawing of this line, impinged by the “C”, as a modifier for a text object. The drawn clipping region could produce many results. For example, other objects could be drawn, dragged or otherwise presented within the text object's clipping region and these objects would immediately become controlled (managed) by the text object. As another example, if the text object itself were duplicated, these clipping regions could define the size of the text object's invisible bounding rectangle. A wide variety of inputs (beyond the drawing of a “C”) could be used to modify a line such that it can be used to program an object. These inputs include, but are not limited to: verbal inputs, gestures, composite objects (i.e., glued objects, or objects in a container of some sort) and assigned objects dragged to impinge a line.

When a clip region is created for a text object this clip region becomes part of the property of that text object and a VDACC object is not needed. So there is no longer a separate object needed to manage the text object, nor is a window needed. The text object itself becomes the manager and can be used to manage other text objects, graphic objects, video objects, devices, web objects and the like. The look of the text object's clip region can be anything. It could look like a rectangular VDACC object. Or a simple look would be to just have vertical lines placed above and below the text object. These lines would indicate where the text would disappear as it scrolls outside the text's clip region. Another approach would be to have invisible boundaries appear visibly only when they are floated over with a cursor, hand (as with gesturing controls), wand, stylus, or any other suitable control in either a 2-D or 3-D environment.

With regards to top and bottom clip boundaries, it would be feasible for a text object to have no vertical clip boundaries on its right or left side. The text's width would be entirely controlled by vertical margins, not the edges of aVDACC object or a computer environment or window. If there were no vertical margins for the text object, then the“clip” boundaries could be the width of a user's computer screen, or handheld screen, like a cell phone screen.

It is important to set forth how the software knows which objects a text object is managing. Whatever objects fall within a text object's clip region or margins could be managed by that text object. A text object that manages other objects is being called a “primary text object” or “master text object.” If clip regions are created for a primary text object and objects fall outside these clip regions, then these objects would not be managed by the primary text object.

A text object can manage any type object, including pictures, devices (switches, faders, joysticks, etc.), animations, videos, drawings, recognized objects and the like. Other methods can be employed to cause a text object to manage other text objects. These methods could include but are not be limited to: (1) lassoing a group of objects and selecting a menu entry or issuing a verbal command to cause the primary text object to manage these other objects, (2) drawing a line that impinges a text object and that also impinges one or more other objects for which the text object is to take ownership, such line would convey an action,like “control”, (3) impinging a primary text object with a second object that is programmed to cause the primary text object to become a “manager” for a group of objects assigned to such second object.

Text objects may take ownership of one or more other objects. There are many ways for a text object to take ownership of one or more objects. One method discussed above is to enable a text object to have its own clipping regions as part of its object properties. This can be activated for a text object or for other objects, like pictures, recognized geometric objects, i.e.,stars, ellipses, squares, etc., videos, lines, and the like. So any object can take ownership of one or more other objects. Therefore, the embodiments herein can be applied to any object. But the text object will be used for purposes of illustration.

Definition of object “ownership: the functions, actions, operations, characteristics, qualities, attributes, features, logics, identities and the like, that are part of the properties or behaviors of one object, can be applied to or used to control, affect, create one or more contexts for, or otherwise influence one or more other objects. For instance, if an object that has ownership of other objects, (“primary object”) is moved, all objects that it “owns” will be moved by the same distance and angle. If a primary object's layer is changed, the objects it “owns” would have its layer changed. If a primary object were rescaled, any one or more objects that its owns would be rescaled by the same amount and proportion, unless any of these “owned” objects were in a mode that prevented them from being rescaled, i.e., they have “prevent rescale” or “lock size” turned on.

This invention provides methods for activating an object to take ownership of one or more other objects. Below are viable methods for enacting such ownership.

Menu: Activate a menu entry for a primary object that enables it to have ownership of other objects.

Verbal command: An object could be selected, then a command could be spoken, like “take ownership”, then each object that is desired to be“owned” by the selected object would in turn be selected.

Drawing gesture: A line or arrow can be drawn such that it encircles, intersects and/or nearly intersects one or more objects to select them, then the same line (or arrow) or another line (or arrow) can be drawn from these selected one or more objects and pointed to the object which is to take ownership of the selected objects.

Hand or object gestures: Creating gestures with the hand or an object can be used to select objects to be owned and then to select one or more objects that are desired to take ownership of the selected objects.

Lasso: Lasso one or more objects where one of the objects is a primary object. The lassoing of other objects included with a primary object could automatically cause all lassoed objects to become “owned” by the primary object. Alternately, a user input could be used to cause the ownership. One or more objects could be lassoed and then dragged as a group to impinge a primary object.

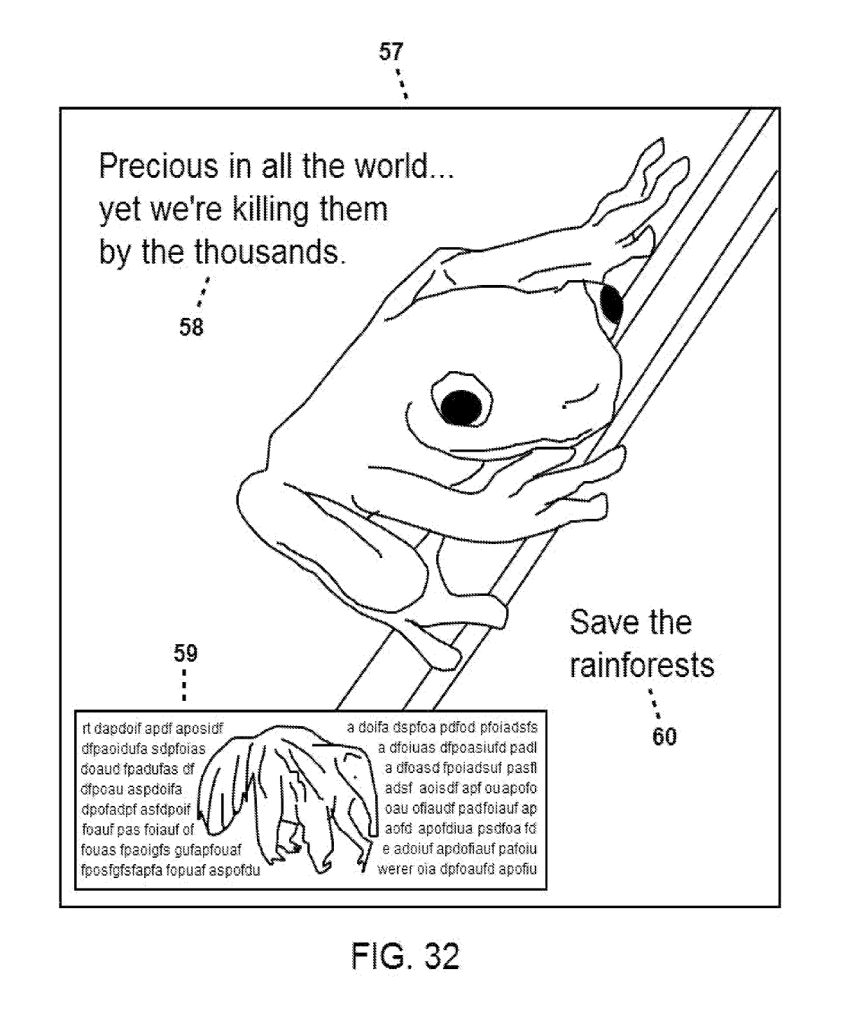

FIG. 32 illustrates that a picture 57 as a primary object could take ownership of other pictures placed on it, thereby enabling a user to easily create composite images. Referring to FIG. 32, the primary object is the picture of the rainforest 57. The other elements are “owned” by the primary picture object. This includes: 58 headline text “Precious in all the world . . . ” 59 an insert containing text and a graphic, and 60 a subhead text: “Save the rainforests.” This approach would greatly facilitate the creation of picture layouts and the creation of composite images.

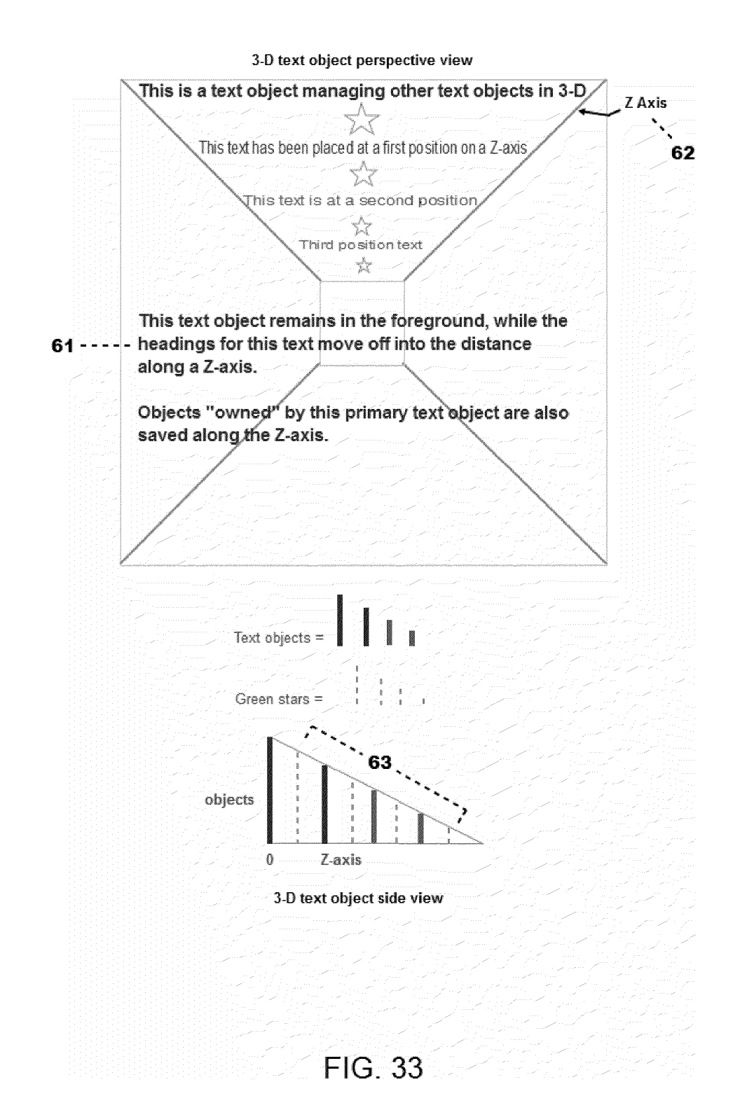

FIG. 33 shows that permitting objects to take ownership of other objects works very well in a 3-D environment. FIG. 33 depicts a text object 61 that has various headings 63 placed along a Z-axis 62.

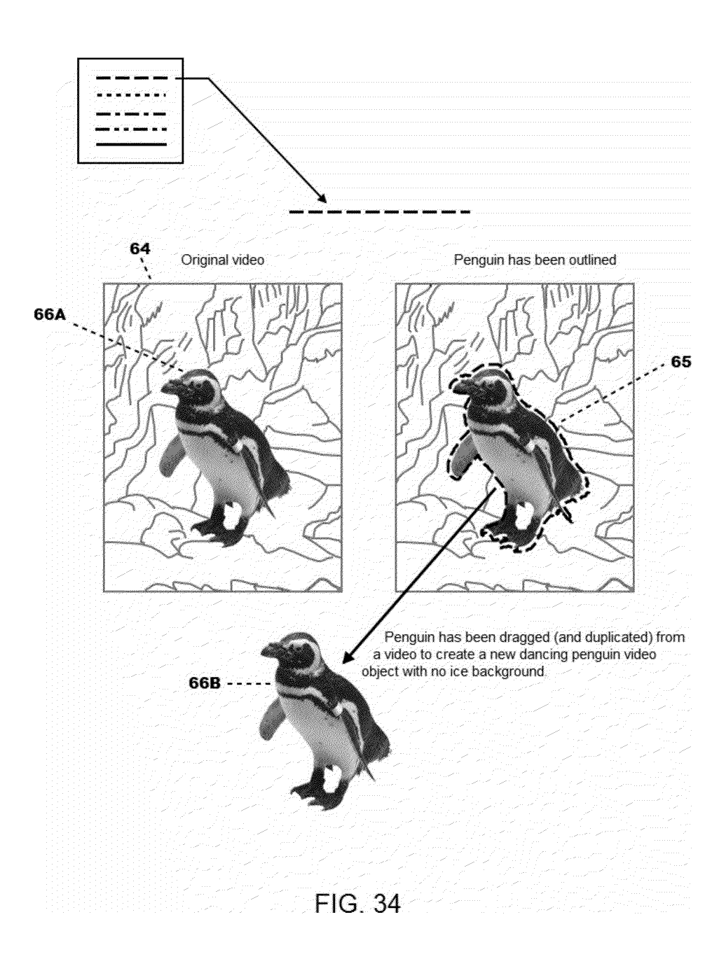

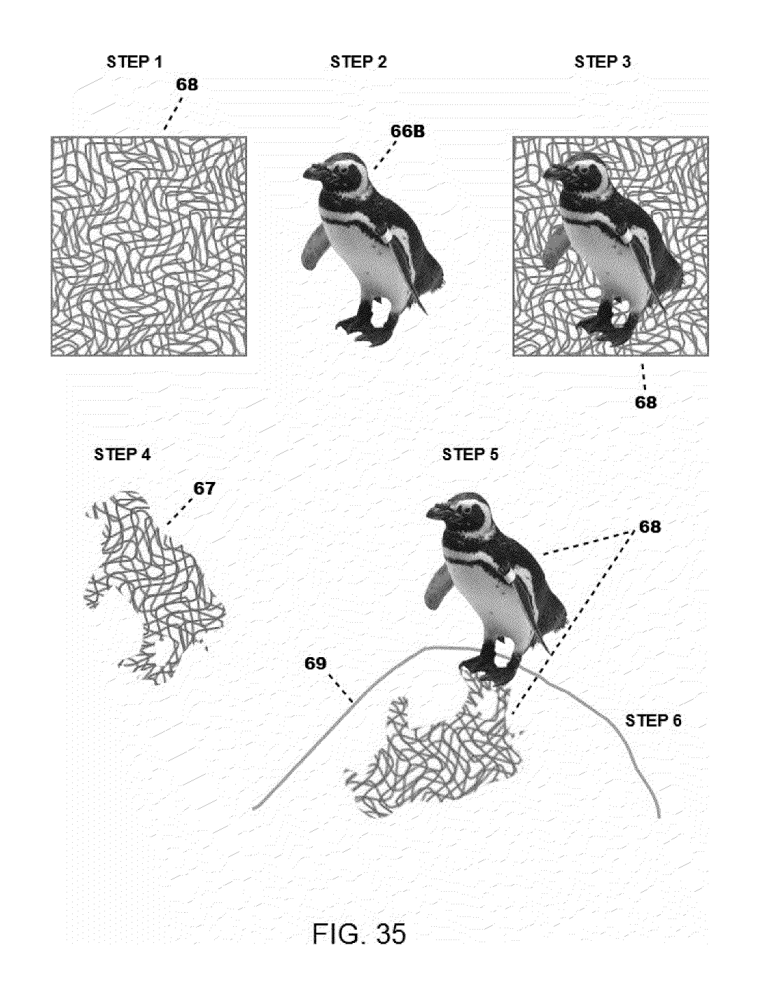

FIG. 34 shows that videos can be primary objects, as in a video of a penguin on ice. An outline 65 has been drawn around the penguin 66A and it has been duplicated and dragged from its video as an individual dancing penguin video with no background 66B. This dragged penguin video can be “owned” by the original video. In this case, the playback, speed of playback, duplication, dragging and any visual or other modification for the “primary video” would control the individual dancing penguin 66B. FIG. 35 is the individual dancing penguin video 66B created in the above example. But this time this penguin video 66B has been made a primary object (primary object penguin video=POPV). The POPV has been placed over a picture 68 and used to crop that picture to create a dancing penguin video silhouette 67. At this point playing video object 66B will automatically play video object 67 because 66B owns 67 This is because 67 was created by using 66B in a creation process, namely, using 66B to crop a picture to create a silhouette video 67 Next video object 66B and video object 67 are dragged to a new location 68. Then video object 67 is rotated 180 degrees to become the shadow for video object 66B. Since video object 66B owns video object 67, playing video object 66B also plays video object 67 automatically. Also, a blue line 69 was drawn to indicate an ice pond. This free drawn line 69 can also be owned by 66B. There are various methods to accomplish this as previously described herein.

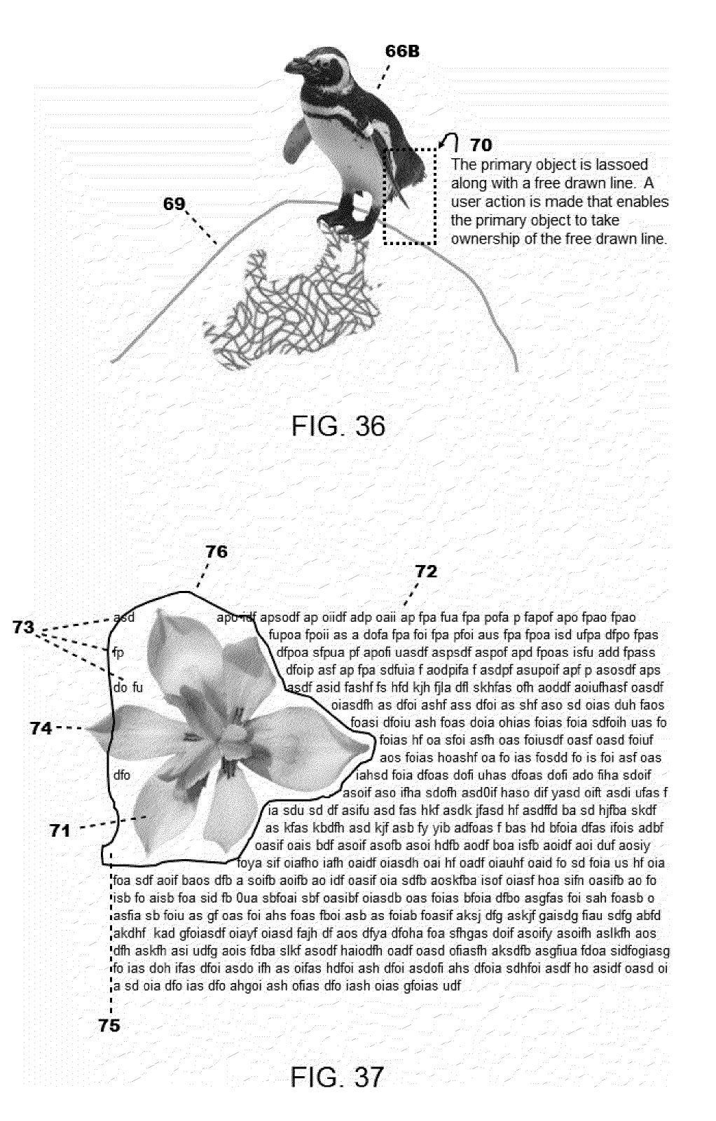

In FIG. 36 example, the POPV 66B and the blue line 69 are lassoed 70 and then a vocal utterance is made (“take ownership”) and video object 66B takes ownership of the blue line 69 as shown below. The primary object is lassoed along with a free drawn line. A user action is made that enables the primary object to take ownership of the free drawn line. This could be a verbal command or a gesture or a drawn object or the like.

### Custom Border Lines

Some pictures cause very undesirable text wrap because of their uneven edges. However, putting them into a wrap square is not the always the desired look. In these cases, being able to draw a custom wrap border for a picture or other object and edit that wrap border can be used to achieve the desired result.

FIG. 37 is a picture 71 with text 72 wrapped around it. Notice that there are some pieces of text 73 to the left of the picture. These pieces could be rewrapped by moving the picture to the left, but the point of the left flower pedal 74 is already extending beyond the left text margin 75. So moving the picture to the left may be undesirable. The solution is a custom wrap border, illustrated in the next four Figures.

FIG. 37 illustrates that a user can free draw a line 76 around a picture 71 to alter it text wrap. The free drawn line 76 simply becomes the new wrap border for the picture 75.This line 76 can be drawn such that the pieces of text 73 that are to the left of the image 71 (in this case a flower) are wrapped to the right of the flower picture 71. FIG. 37 illustrates the drawing of such a “wrap border line.” Note: if the line 76 is drawn inside the picture's 71 perimeter, the wrap border is determined by the picture's perimeter, but if the line 76 is drawn outside the picture's 71 perimeter, the wrap border is changed to match the location of the drawn line 76.

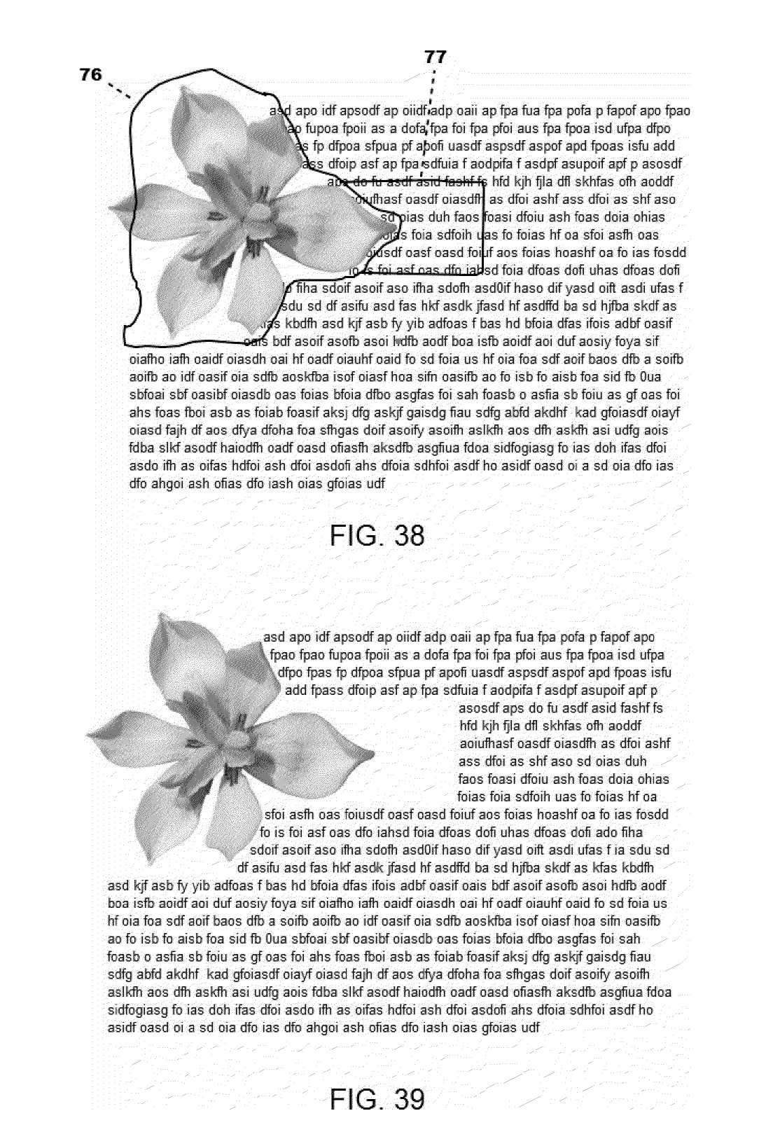

FIG. 38 shows a method to alter the custom text wrap line (“border line”) of FIG. 37. The originally drawn border line 76 can be shown by methods previously described. Once the border line 76 is shown, it can be altered by drawing one or more additional lines and appending these to the original border line or directly altering the shape of the existing line by stretching it or rescaling it. Many possible methods can be used to accomplish these tasks. For instance, to “stretch” the existing border line, you could click (touch) on two places on the line and use rescale to change its shape between the two clicked points. Alternately, you could draw an additional line 77 that impinges the existing border line and modifies its shape as shown in FIG. 38. The added line 77 can be appended to the originally drawn border line by a verbal utterance, a context (e.g., drawing a new line drawn to impinge an existing border line causes an automatic update of the impinged line), having the additional line be a gesture line, programmed with the action “append”, etc. The result is shown in FIG. 39. The text wrap border has been changed to include the drawn rectangle line which impinges the existing border line.

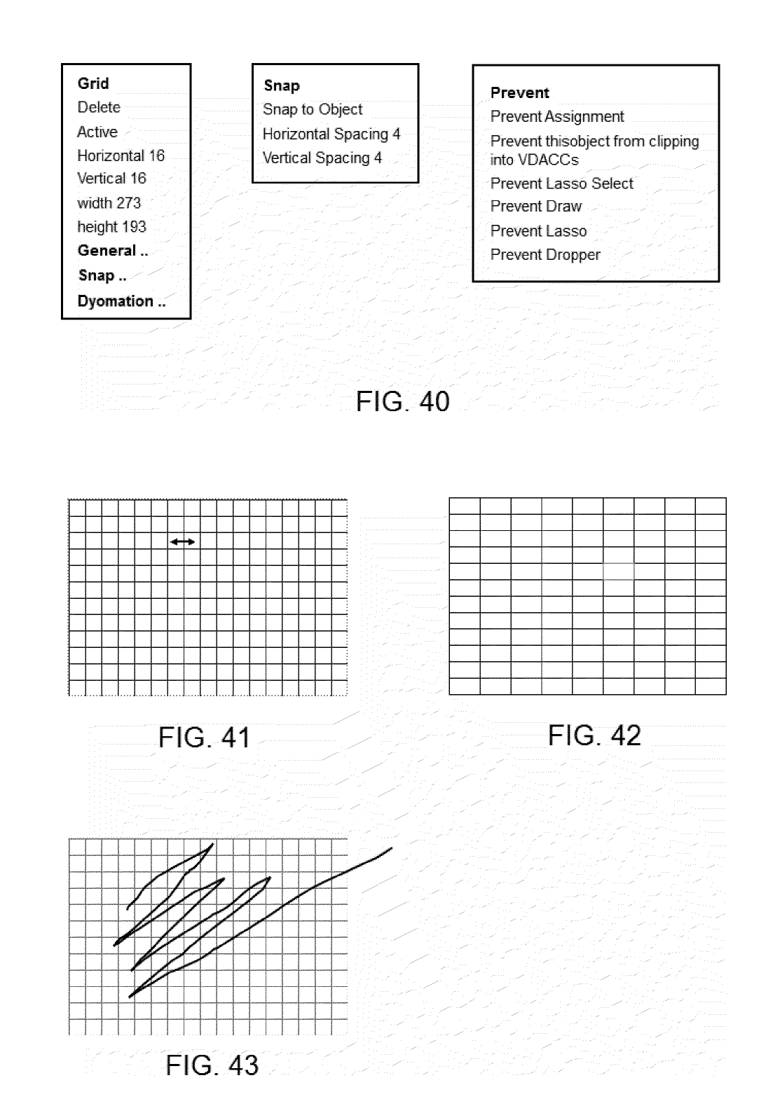

FIG. 40 depicts some of the menu and menu entries that are removed and replaced by graphic gestures of this invention. First, the Grid Menu. It contains controls for the overall width and height of a grid and the width of each horizontal and vertical square. These menu items can be eliminated by the following methods. Removing the menu entries for the overall width and height dimensions of a grid can be accomplished by floating the mouse cursor over or touch with a finger or pen on the lower right corner of a grid and the cursor turns into a double arrow or some other suitable graphic. If a user then drags outward or inward they will change the dimension of both the width and height of the grid. Float one's mouse cursor or its equivalent over the corner of a grid and hold down the Shift key or an equivalent. Then when one drags in a horizontal direction this drag will change only the width dimension of the grid. If one drags in a vertical direction, this will change only the height of the grid. To remove the grid menu items for the horizontal and vertical size of grid “squares” (or rectangles) that make up a grid, hold down a key, like Alt, then float the mouse cursor over any individual grid “square” or apply a finger touch to the edge of a grid square. Drag to the right or left to change the width of the “square”. Drag to up or down to change the height of the “square.” See FIGS. 41 and 42. Dragging to the right in FIG. 41 causes the width of the grid squares to be lengthened as shown in FIG. 42. FIG. 43 illustrates a method for removing the need for the “delete” entry for a Grid. The solution is to scribble over the grid. Some number of back and forth lines deletes the grid, for example, seven back and forth lines.

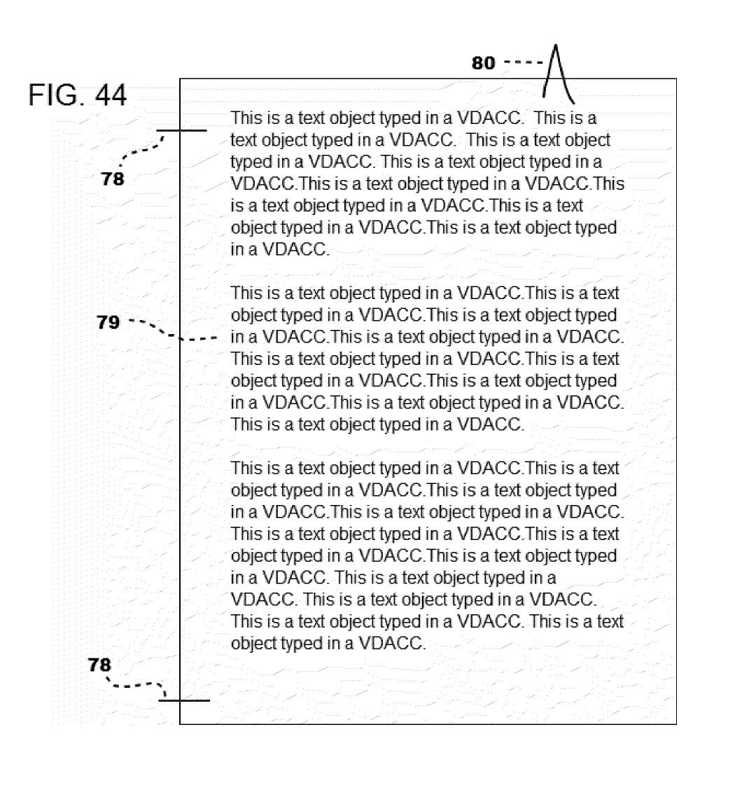

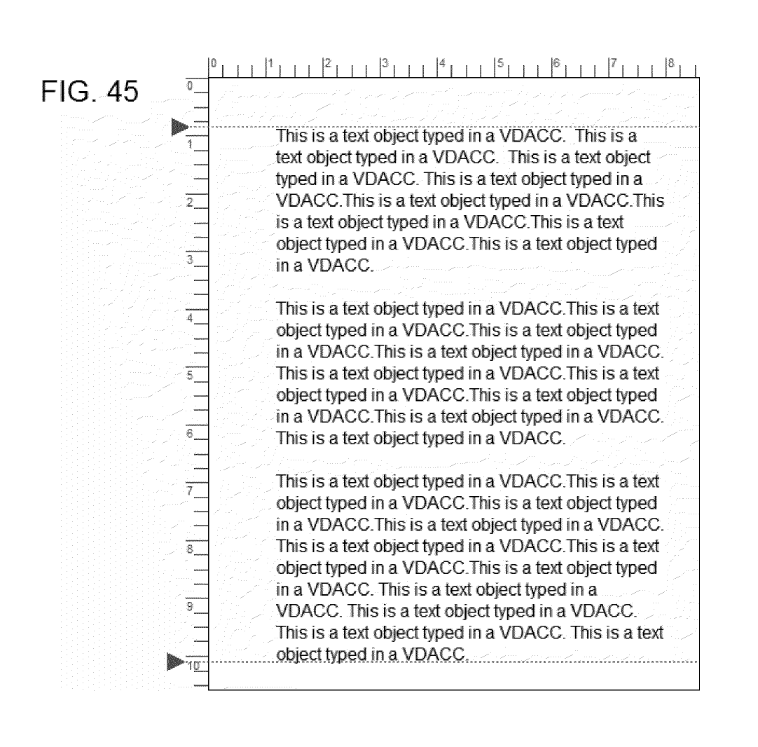

FIG. 44 illustrates an alternative to adjusting margins for text in a VDACC object. Draw one or more gesture lines that intersect the left edge of a VDACC object containing a text object. The gesture line could be programmed with the following action: “Create a vertical margin line.” A gesture object could be used to cause a ruler to appear along the top and left edges of the VDACC object. In FIG. 44, two blue gesture lines 78 have been drawn to create top and bottom margin lines for a text object 79, and a gesture object 80 has been drawn to cause rulers to appear. The result is shown in FIG. 45.

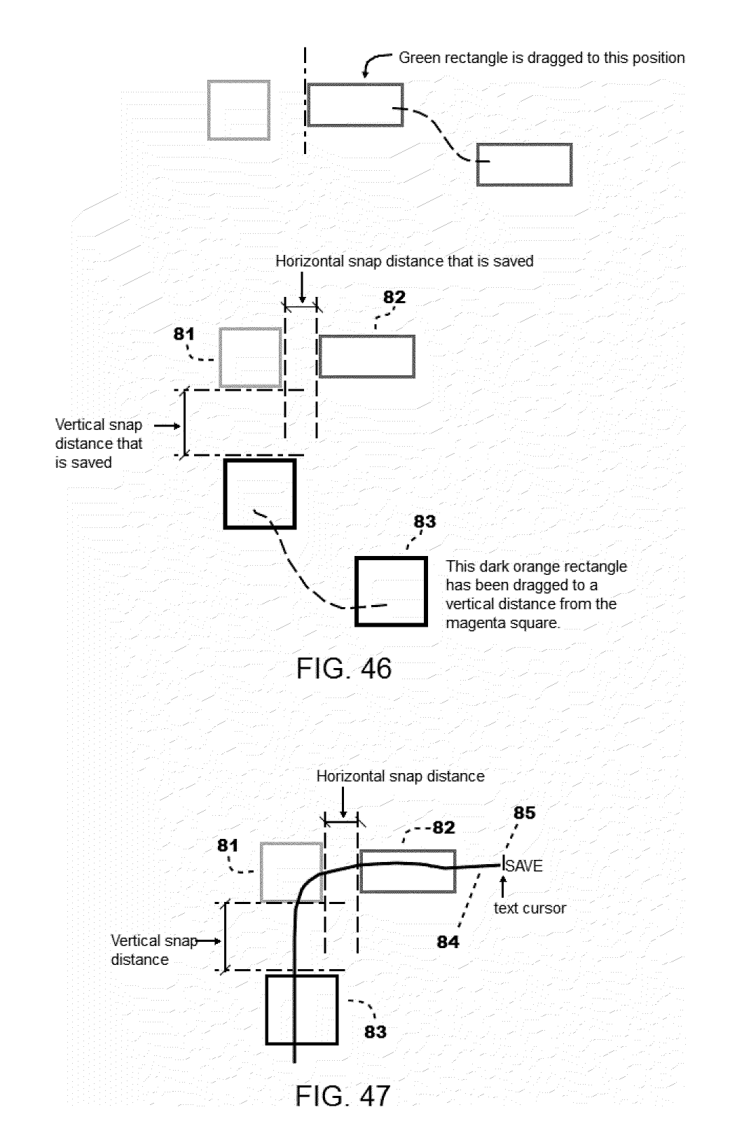

Eliminating the menus for Snap (FIG. 40) is illustrated in FIGS. 46-52. The following methods can be used to eliminate the need for the snap menu:

Vocal commands. Engaging snap is a prime candidate for the use of voice. To engage the snap function a user need only say “snap.” Voice can easily be used to engage new functions like, snapping one object to another where the size of the object being snapped is not changed. To engage this function a user could say: “snap without rescale” or “snap, no resize,” etc.

Graphic activation of a function. This is a familiar operation in Blackspace. Using this, a user would click on a switch or other graphic to turn on the snap function for an object. This can be enacted by placing an object onscreen or by drawing an object or enabling the user to create a graphic equivalent for such object.

Programming functions by dragging objects. Another approach would be the combination of a voice command and the dragging of one or more objects. One technique to make this work will eliminate the need for all Snap menus.
1) Issue a voice command, like: “set snap” or “set snap distance” or “program snap distance” or just “snap distance”. Equivalents are as usable for voice commands as they are for text and graphic commands in Blackspace.
2) Click on the object for which you want to program “snap.”
3) Issue a voice command, e.g., “set snap distances.” Select a first object to which this command is to be applied. [Or enable this command to be global for all objects or select an object and then issue the voice command]. Drag a second object to the first object, but don't intersect the first object. The distance that this second object is from the first object when a mouse up-click or its equivalent is performed, determines the second object's position in relation to the first object. This distance programs the first object's snap distance.

If the drag of the second object was to a location to the right or left of the first object, this sets the horizontal snap distance for the first object. If the second object was dragged to a location below or above the first object, this sets the vertical snap distance for the first object. Let's say the drag is horizontal. Then if a user drags a third object to a vertical position near the first object,this sets the vertical snap distance for the first object.

Conditions:

User definable default maximum distance—a user preference can exist where a user can determine the maximum allowable snap distance for programming a snap space (horizontal or vertical) for a Blackspace object. So if an object drag determines a distance that is beyond a maximum set distance, that maximum distance will be set as the snap distance.

Change size condition—a user preference can exist where the user can determine if objects snapped to a first object change their size to match the size of the first object or not. If this feature is off, objects of the same type but of different sizes can be snapped to each other without causing any change in the size of either object.

Snapping different object types to each other—a user preference can exist where the user can determine if the snapping of objects of differing types will be allowed, i.e., snapping a switch to a picture or piece of text to a line, etc.

Saving snap distances. There are different possibilities here, which could apply to changing properties for any object in Blackspace.

Automatic save. A first object is put into a “program mode” or “set parameter mode.” This can be done with a voice command, i.e., “set snap space.” Then when a second object is dragged to within a maximum horizontal or vertical distance from this first object and a mouse up-click (or its equivalent) is performed, the horizontal or vertical snap distance is automatically saved for the first object or for all objects of its type, i.e., all square objects, all star objects, etc.

Drawing an arrow to save. Referring to FIG. 47, an arrow (which could be a drawn or gestured line) is created to impinge all of the objects that comprise a condition or set of conditions (a context) for the defining of one or more operations for one or more objects within this context.

Referring to FIG. 46, a “set snap mode” has been activated by any known means, e.g., verbal, drawing, activating an object, recalling an assignment, or the like. A rectangle object 82 has been dragged to within a certain distance to square object 81 to the horizontal snap distance. A second object 83 is being dragged to a position below square object 81 to set the vertical snap distance. Referring to FIG. 47, an arrow line 84 has been drawn to impinge all three objects, 81, 82 and 83. A text cursor 85 appears near the end of this arrow line and the an action is entered for the arrow line. In this case it is “save.” When the arrow is activated, the horizontal and vertical snap distances as determined by the positions of objects 82, 82 and 83 are saved. Referring again to FIG. 47, the context includes the following conditions:
(1) A verbal command “set snap space” has been uttered.
(2) A first object (a square) 81 has been selected immediately following this verbal utterance.
(3) A second 82 and third 83 object have been dragged to determine a horizontal and vertical snap distance for the first object.
   When the arrow 84 is drawn, a text cursor 85 could automatically appear to let the user draw or type a modifier for the arrow. In this case it would be “save.” As an alternate, clicking on the white arrowhead or other graphic, requiring a user action to activate the arrow, could automatically cause a “save” and there would be no need to type or otherwise enter any modifier for the arrow.

Verbal save command. Here a user would need to tell the software what they want to save. In the case of the example above, a verbal utterance would be made to save the horizontal and vertical snap distances for the square 81. There are many ways to do this. Below are two of them.

First Way: Utter the word “save” immediately after dragging the third object 83 to the first 81 to program a vertical snap distance.

Second Way: Click on the objects that represent the programming that you want to include in your save command. For example if the user wants to save both the horizontal and vertical snap distances, one could click only on the square 81 or on the square 81 and then on object 82 and 83 that set the snap distances for the square object 81. If one wanted to only save the horizontal snap distance for the square 81, one could click on the square 81 and then on the rectangle 82 or only on the rectangle 82, as the subject of this save is already the square 81.

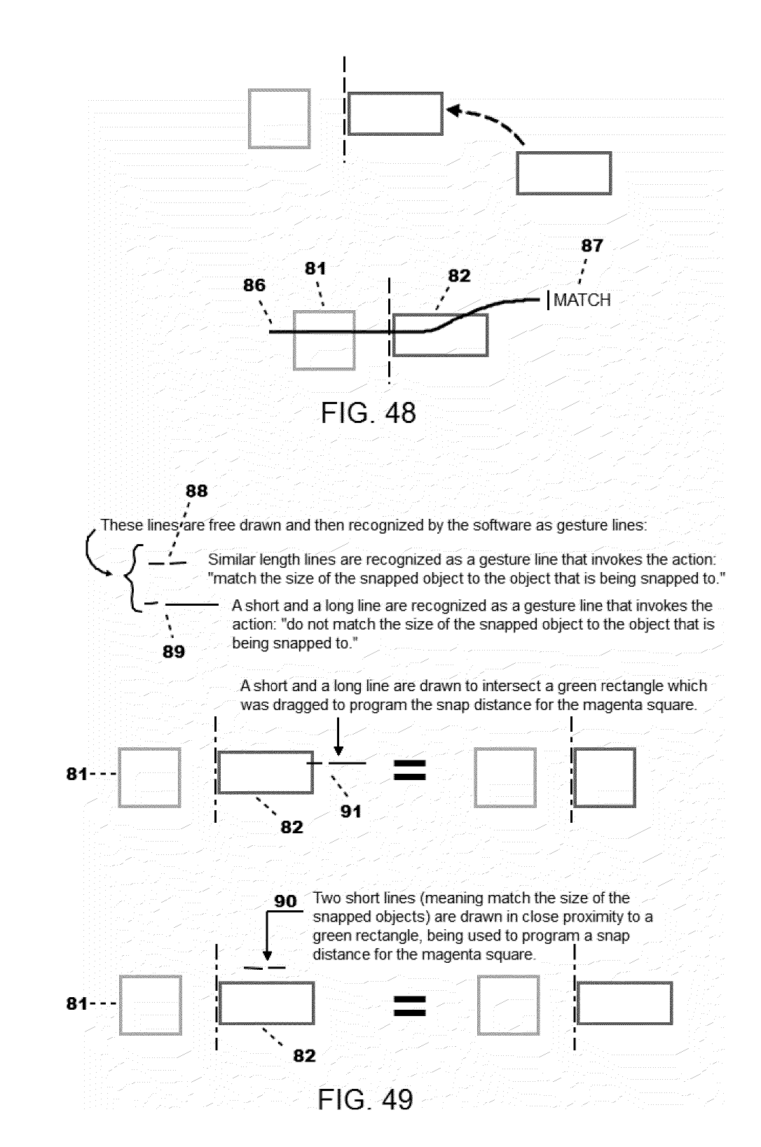

Change Size Condition. A user can determine whether a snapped object must change its size to match the size of the object it is being snapped to or whether the snapped object should retain its original size and not be altered when it is snapped to another object. This can be programmed by the following methods: Arrow—Referring to FIG. 48, an arrow line 86 is drawn to impinge a first 81and second 82 object. Then type, speak or draw an object to initiate a command: “match size” 87—a specifier of the arrow's action. As with all commands in Blackspace, any equivalent that can be recognized by the software is viable here.

Verbal command. Say a command that causes the matching or not matching of sizes for snapped objects, i.e., “match size” or “don't match size.”

Draw one or more Gesture Objects—Referring to FIG. 49, a gesture line be used to program snap distance. It could consist of two equal 88 or unequal length 89 lines which would be hand drawn and recognized by the software as a gesture line. This would require the following:
(1) A first object 81 exists with its snap function engaged (turned on).
(2) Two lines are drawn of essentially equal length 90 (e.g. that are within 90% of the same length) to cause the action: “change the size of the dragged object to match the first object.” Or two lines of differing lengths 91 are drawn to cause the opposite action.
(1) The two lines are drawn within a certain time period of each other, e.g., 1.5 seconds, in order to be recognized as a gesture object.
(3) Such recognized gesture object is drawn within a certain proximity to a first object with “snap” turned on. This distance could be an intersection or a minimum default distance to the object, like 20 pixels. These drawn objects don't have to be lines. In fact, using a recognized object could be easier to draw and to see onscreen. Below is the same operation as illustrated above, but instead of drawn lines, objects are used to recall gesture lines.

Pop Up VDACC object. This is a traditional but useful method of programming various functions for snap. When an object is put into snap and a second object is dragged to within a desired proximity of that object, a pop up VDACC object could appear with a short list of functions that can be selected.

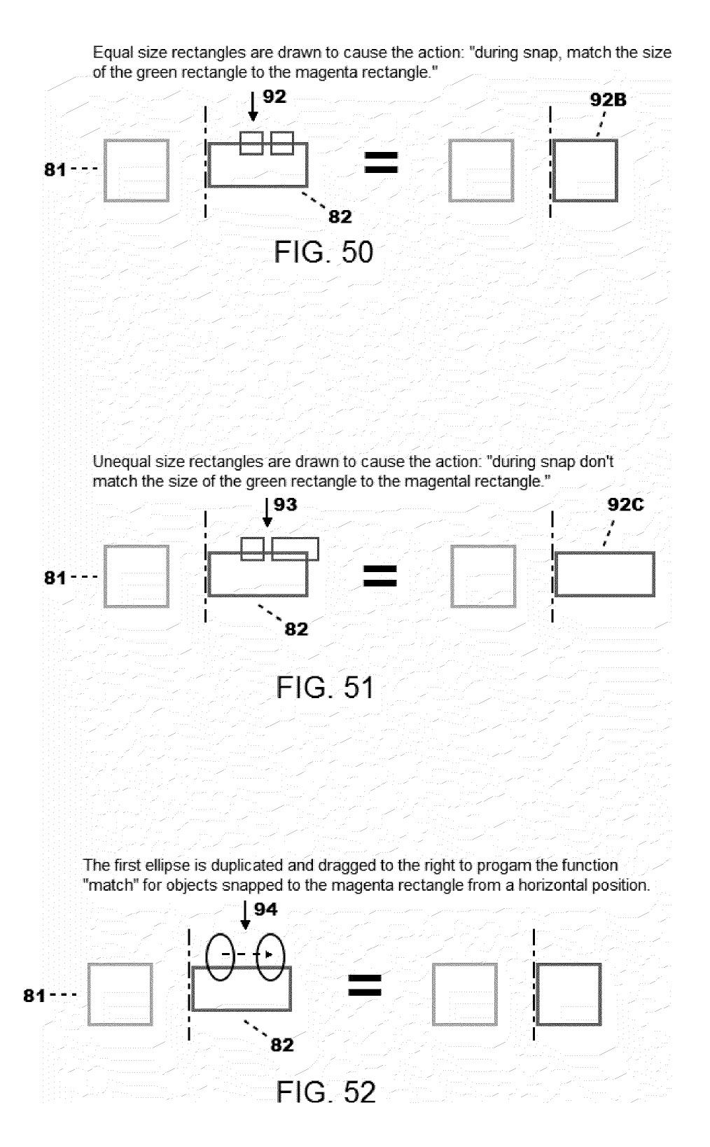

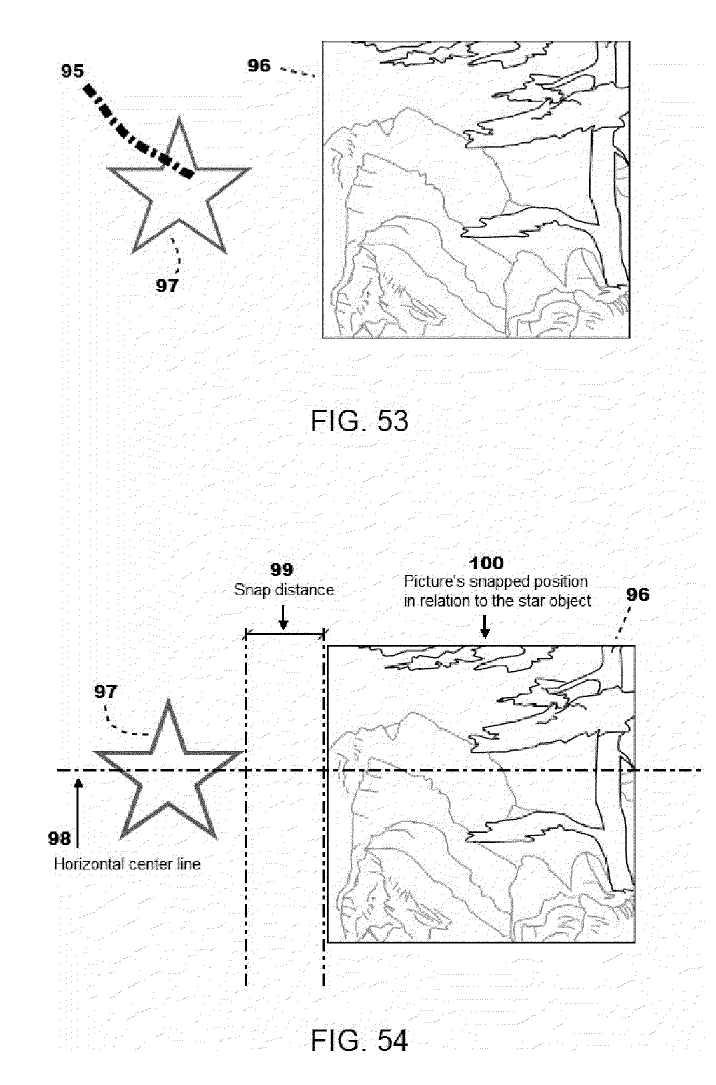

FIGS. 50 and 51 illustrate the use of geometric figures to program size for a snap function. Referring to FIG. 50, two geometric objects of essentially the same size 92 are drawn to impinge a rectangle object 82. The result is that this object matches the size of object 81 when it is snapped to it—see object 92B. Referring to FIG. 51, two geometric figures of unequal size are drawn to impinge rectangle 82. The result is that this rectangle object 82 retains its original size when it is snapped to object 81—see object 92C. FIG. 52 illustrates the use of the duplicate command to duplicate a geometric object. This pair of objects is dragged to impinge a rectangle object that is being snapped to a square 81. The result is the rectangle object changes its size to match the object 81 to which it is snapped. FIG. 53 illustrates snapping non-similar object types to each other. The snap can accommodate non-similar object types. The following explains a way to change the snap criteria for any object from requiring that a second object being snapped to a first object perfectly match the first object's type. This change would permit objects of differing types to be snapped together. The following gestures enable this.

Drawing to snap dissimilar objects to each other. One method would be to use a gesture object that has been programmed with the action “snap dissimilar type and/or size objects to each other.” The programming of gesture objects is discussed in pending application Ser. No. 12/653,056, filed Dec. 8, 2009, titled “METHOD FOR USING GESTURE OBJECTS FOR COMPUTER CONTROL,” which is incorporated herein by reference.

Referring to FIG. 53, a gesture line 95 that equals the action, “turn on snap and permit objects of dissimilar types and sizes to be snapped to each other,” has been drawn to impinge a star object 97. This changes the snap definition of the star from its default, which is to only permit like objects to be snapped to it, e.g., only star objects, to now permitting any type of object, like a picture, to be snapped to it. The picture object 96 can then be dragged to intersect the star 95 and this will result in the picture 96 being snapped to the star 95. The snap distance can either be a property of the gesture line or a property of the default snap setting for the star, or set according to a user input.

FIG. 54 illustrates the result of the above example where a picture object 96 has been dragged to snap to a star object. The default for snapping objects of unequal size is that the second object snaps in alignment to the center line 98 of the first object. Shown below a picture object 96 has been snapped horizontally to a star object 97. As a result, the picture object 96 has been aligned to the horizontal center line 98 of the star object 97 at a snap distance 99.

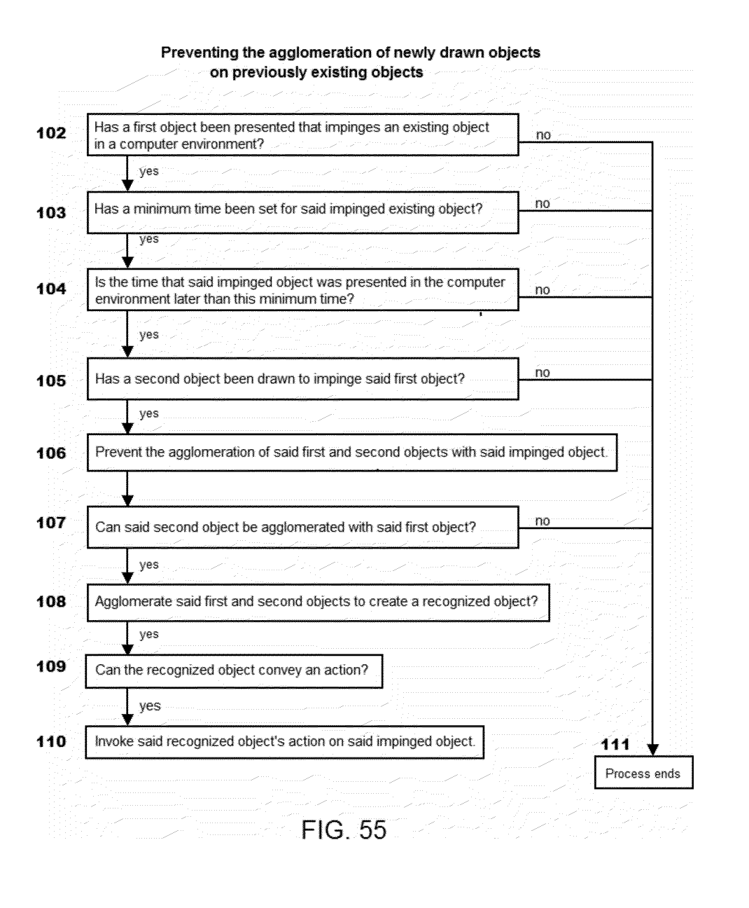

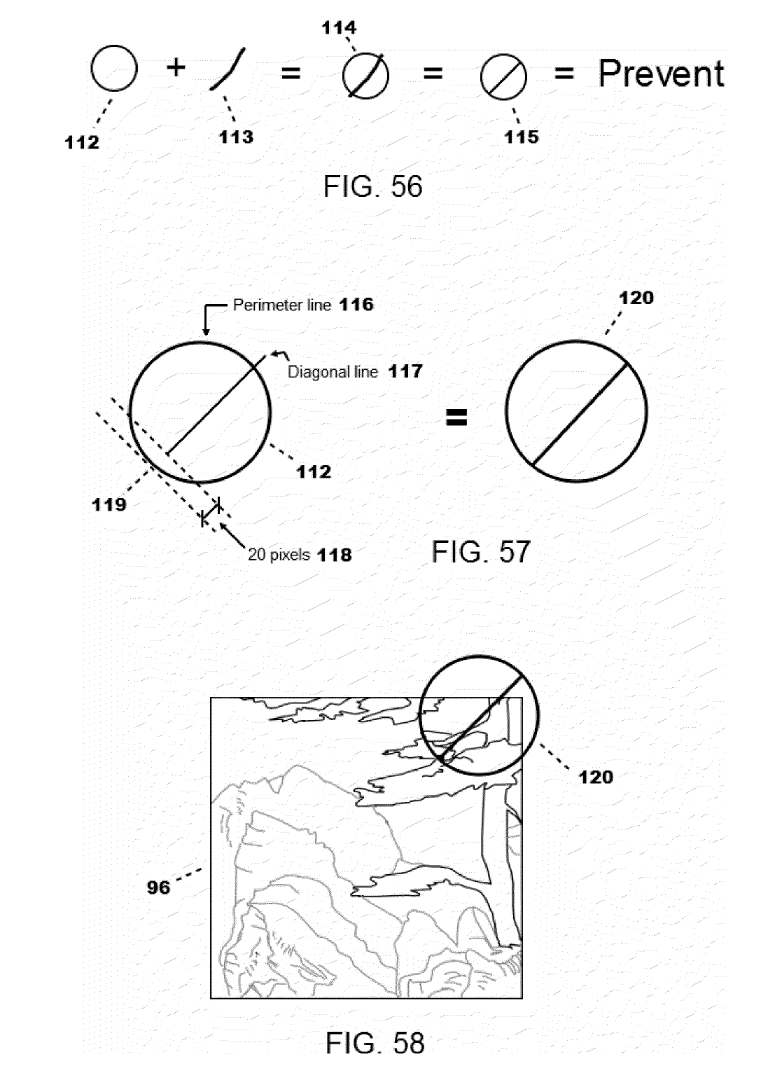

FIGS. 55 and 56 illustrate eliminating the Prevent menus known in the prior art and widely used in Blackspace. Prevent by drawing uses a circle with a line through it: a universal symbol for “no” or “not valid” or“prohibited.” The drawing of this object can be used for engaging “Prevent.” To create this object a circle is drawn followed by a line through the diameter of the circle, as shown in Referring to FIG. 56, the “prevent” graphic is created by drawing first a recognized circle 112. Then a line 113 is drawn to intersect the circle 114. Then the software recognizes the two objects as an agglomeration and creates a computer rendered “prevent” object 115. Referring to FIG. 57, the method of computer recognition of drawn inputs as a “prevent” graphic is shown. A circle object 112 is presented (via drawing, recall, gesture, verbal command, or any other viable method). A diagonal line 117 is drawn that intersects the perimeter 116 of the circle object 112 such that the end of the diagonal line ends within 20 pixels 118 of the opposing perimeter edge 119 of the circle 112. If this condition is present the software recognizes the diagonal line 117 as an agglomeration to the circle 112 and creates a “prevent” object 120. Regarding the utilization of the “prevent object” it is presented to impinge other objects to program them with a “prevent” action. To enable the recognition of this “prevent” object, the software is able to recognize the drawing of new objects that impinge one or more previously existing objects, such that said previously existing objects do not affect the recognition of the newly drawn objects. The need is to permit a circle 112 and diagonal line 117 to be drawn such one or both of these objects can impinge an existing graphic such that this impingement does not interfere with and prevent the software's recognition of the circle and diagonal line as a prevent object. The software accomplishes this by preventing the agglomeration of newly drawn objects with previously existing objects. One method to do this is for the software to determine if the time that previously existing objects were drawn is greater than a minimum time, then the drawing of new objects that impinge these previously existing objects will not result in the newly drawn objects agglomerating to the previously drawn objects.

Definition of agglomeration: this provides that an object can be drawn to impinge an existing object, such that the newly drawn object, in combination with the previously existing object (“combination object”) can be recognized as a new object. The software's recognition of said new object results in the computer generation of the new object to replace the two or more objects comprising said combination object. Note: an object can be a line.

Preventing the agglomeration of newly drawn objects on previously existing objects. See FIG. 55 flow chart, it contains the following steps.
1. Step 102: Has a new (first) object been drawn such that it impinges an existing object? An existing object is an object that was already in the computer environment before the first object was presented. An object can be “presented” by any of the following means: dragging means, verbal means, drawing means, context means, gesture means and assignment means.
2. Step 103: A minimum time can be set either globally or for any individual object. This “time” is the difference between the time that a first object is presented (e.g., drawn) and the time that a previously existing object was presented in a computer environment.
3. Step 104: Is the time that the previously existing object (that was impinged by the newly drawn “first” object) was originally presented in a computer environment greater than this minimum time?
4. Step 105: Has a second object been presented such that it impinges the first object? For example, if the first object is a circle, then the second object could be a diagonal line drawn through the circle, as shown in FIG. 57.
5. Step 106: The agglomeration of the first and second objects with the previously existing object is prevented. This way the drawing of the first and second objects can't agglomerate with the previously existing object and cause it turned into another object.
6. Step 107: When the second object impinges the first object can the computer recognize this impinging as a valid agglomeration of the two objects?
7. Step 108: The impinging of the first object with these second object are recognized by the software and as a result of this recognition the software replaces both the first and second objects with a new computer generated object.
8. Step 109: Can the computer generated object convey an action to an object that it impinges? Note: turning a first and second object into a computer generated object, results in having that computer generated object impinge the same previously existing object that was impinged by the first and second objects.
9. Step 110: Apply the action that can be conveyed by the computer generated graphic to the object that it is impinging. For instance, if the computer generated object conveyed the action: “prevent,” then the previously existing object being impinged by the computer generated object would have the action “prevent” applied to it.
   In this way a recognized graphic that conveys an action can be drawn over any existing object without the risk of any of the newly drawn strokes causing an agglomeration with the previously existing object.

The conditions of this new recognition are as follows:
(1) According to a determination of the software or via user-input, the newly draw one or more objects will not create an agglomeration to any previously existing object.
(2) The drawn circle can be drawn in the Recognize Draw Mode. The circle will be turned into a computer generated circle after it is drawn and recognized by the software.
(3) The diagonal line can be drawn thorough the recognized circle. But if the circle is not recognized, when the circle is intersected by the diagonal line no “prevent object” will be created.
(4) The diagonal line must intersect at least one portion of a recognized circle's circumference line (perimeter line) and extend to some user-definable length, like to a length equal to 90% of the diameter of the circle or to a definable distance from the opposing perimeter of the circle, like within 20 pixels 118 of the opposing perimeter 119, as shown in FIG. 57.

FIG. 58 illustrates using a “prevent object”. A circle with a line drawn through it is drawn over an object such that the software recognizes the circle and diagonal line as a prevent object 120, even though their drawing impinges a picture 96. It should also be noted that if a prevent object 120 is drawn in blank space in a computer environment, like Blackspace, this will engage the Prevent Mode.

Prevent Assignment—to prevent any object from being assigned to another object, draw the “prevent object” to impinge the object. The default for drawing the prevent object to impinge another object can be “prevent assignment,” and the default for drawing the prevent object in blank space could be: “show a list of prevent functions.” Such defaults are user-definable by any known method.

In summary, the drawing of a prevent object, as shown in FIG. 58, must be able to be drawn over any existing graphic, e.g., a picture, drawing, any object, text, line, video, chart, website, etc. Furthermore, the existing graphics must not interfere with the software's ability to recognize a properly drawn prevent object.

FIG. 59 illustrates a prevent object drawn as a single stroke object 121. In this case the recognition of this object 121 would require a drawn ellipse 124 where the bisecting line 123 extends through the diameter of the drawn ellipse 124.

FIG. 60 illustrates a more complex use of the prevent object. This example uses the drawing of an assignment arrow 125 that intersects and encircles various graphic objects. Each object that is not to be a part of the assignment has a prevent object 120, 121 drawn over it, thus excluding it from the assignment arrow action.

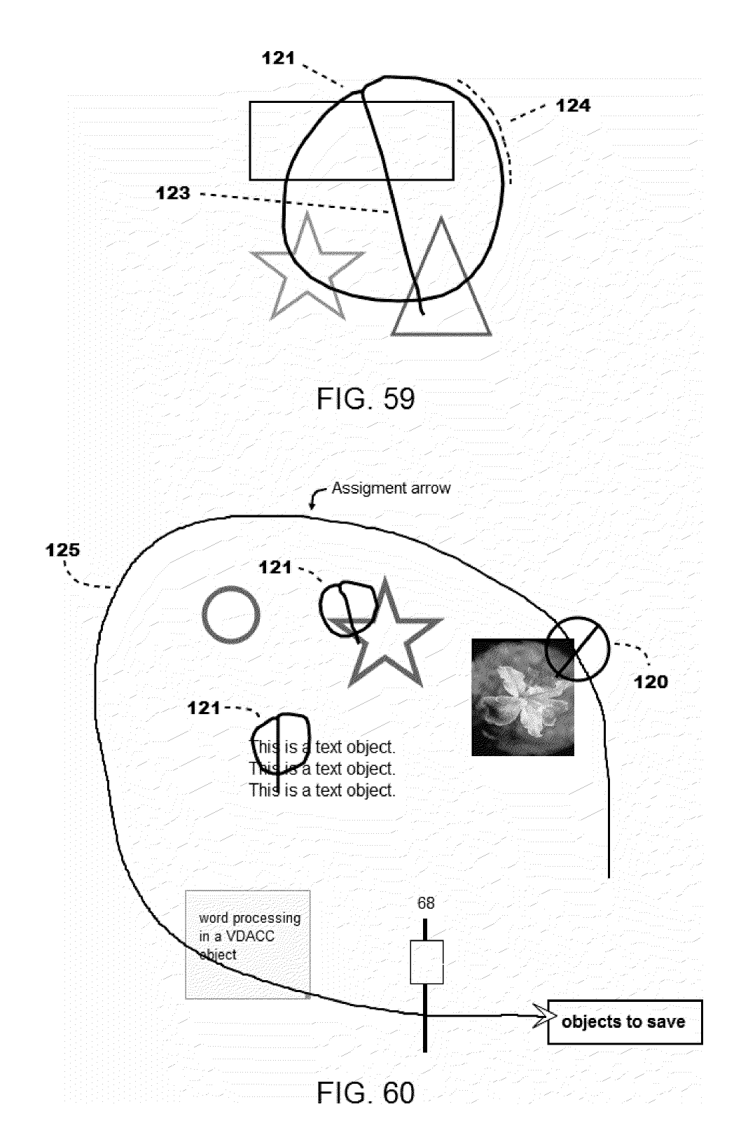

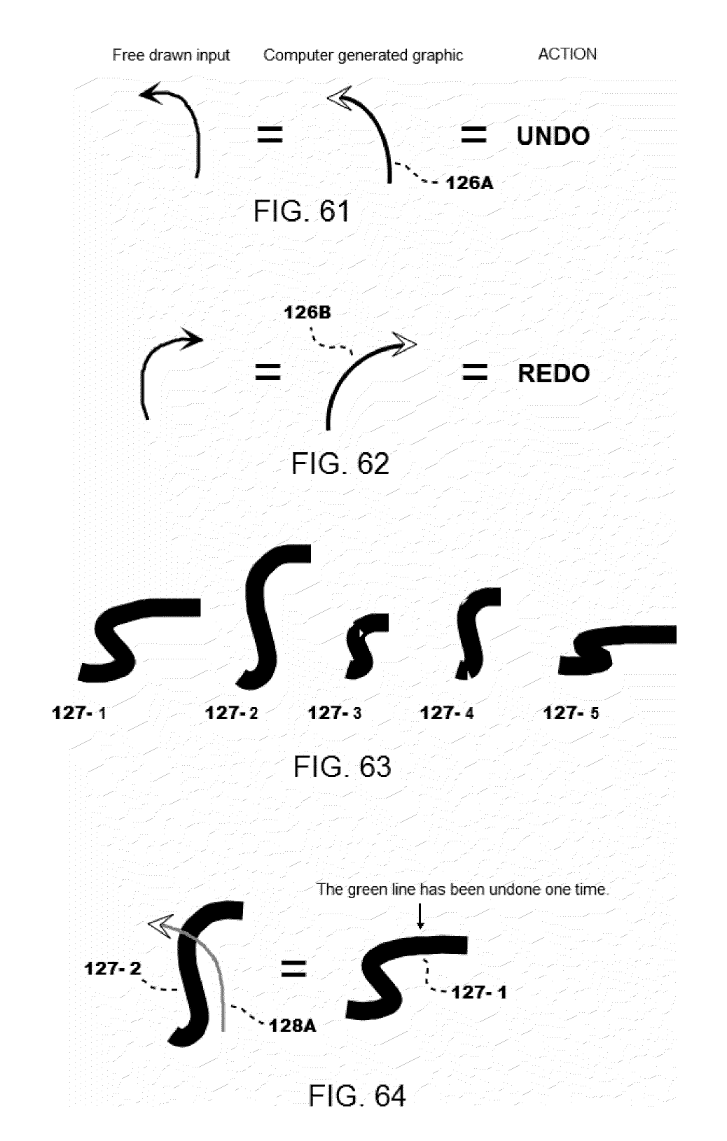

The invention may also remove menus for the UNDO function and substitute graphic gesture methods. This is one of the most used functions in any program. This action can be called forth by graphical drawing means. FIGS. 61 and 62 are two possible graphics that can be drawn to invoke undo and redo. The objects shown above are easily drawn to impinge any object that needs to be redone or undone. This arrow shape 126A or 126B does not cause any agglomeration when combined with any other object or combination of objects.

Combining graphical means with a verbal command. If a user is required to first activate one or more drawing modes by clicking on a switch or on a graphical equivalent before they can draw, the drawing of objects for implementing software functions is not as efficient as it could be.

A potentially more efficient approach would be to enable users to turn on or off any software mode with a verbal command. Regarding the activation of the recognize draw mode, examples of verbal utterances that could be used are: “RDraw on”—“RDraw off” or “Recognize on”—“Recognize off”, etc.

Once the recognize mode is on, it is easy to draw an arrow curved to the right for Redo 126B and an arrow curved to the left for Undo 126A.

Combining drawing recognized objects with a switch on a keyboard or cell phone, etc. For hand held devices, it is not practical to have software mode switches onscreen. They take up too much space and will clutter the screen thus becoming hard to use. But pushing various switches, like number switches, to engage various modes could be very practical and easy. Once the mode is engaged, in this case, Recognize Draw, drawing an Undo and Redo graphic to impinge any object is easy.

Using programmed gesture lines. As explained herein a user can program a line or other objects that have recognizable properties, like a magenta dashed line, to invoke (or be the equivalent for) any definable action, like Undo or Redo. The one or more actions programmed for the gesture object would be applied to the one or more objects impinged by the drawing of the gesture object.

Multiple UNDOs and REDOs. One approach is to enable a user to modify a drawn graphic that causes a certain action to occur, like an arched arrow to cause Undo or Redo. First a graphic would be drawn to cause a desired action to be invoked. That graphic would be drawn to impinge one or more objects needing to be undone. Then this graphic can be modified by graphical or verbal means. For instance a number could be added to the drawn graphic,like a Redo arrow. This would Redo the last number of actions for that object. In FIG. 63 the line 127-1 has been rescaled 4 times, each result numbered serially, 127-2, 127-3, 127-4, 127-5. In FIG. 64 the graphic resize 127-2 has been impinged on by an Undo graphic 128A, the result being the display of graphic 127-1. Likewise, in FIG. 65 the graphic 127-1 has been impinged on by a Redo arrow 128B modified with a multiplier “4”. The result is that the 127-1 graphic has been redone 4 times, resulting in graphic resize 127-5 being displayed.

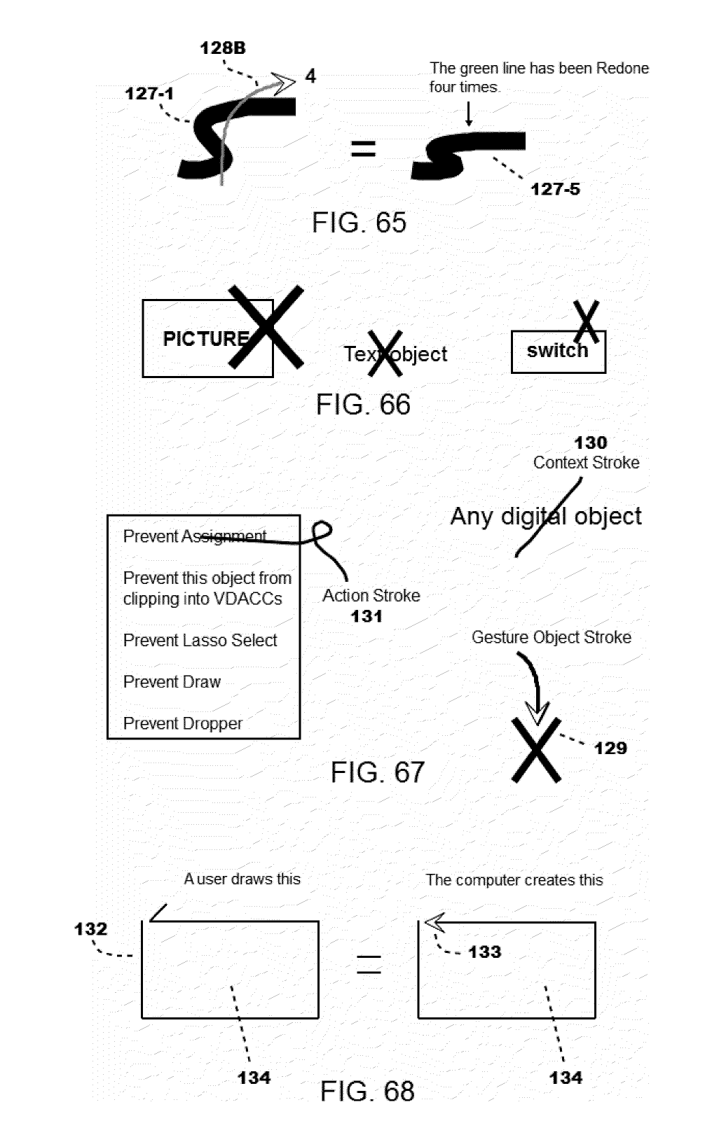

With regard to FIG. 66, although Blackspace already has one graphic designated for deleting something (the scribble), an X is widely recognized to designate this purpose as well. As shown in FIG. 67, a red X, 129, can be programmed as a gesture object to perform a wide variety of functions. The Context Stroke 130, used to program the X is: “Any digital object.” So any digital object impinged by the red X 129 will be a valid context for the red X gesture object 129. The Action Stroke 131 impinges an entry in a menu: “Prevent Assignment.” Thus the action programmed for the red X gesture object 129 is: “Prevent Assignment. Any object that has a red X drawn to impinge it will not be able to be assigned to any other object. To allow the assignment of an object impinged by such a red X, delete the redX or drag it so that it no longer impinges the object desired to be assigned. The Gesture Object Stroke points to a red X 129. This is programmed to be a gesture object that can invoke the action: “prevent assignment.” To use this gesture object,either draw it or drag it to impinge any object for which the action “prevent assignment” is desired to be invoked.

The removing of menus as a necessary vehicle for operating a computer serves many purposes: (a) it frees a user from having to look through a menu to find a function, (b) whenever possible, it eliminates the dependence upon language of any kind, (c) it simplifies user actions required to operate a computer, and (d) it replaces computer based operations with user-based operations.

Selecting Modes
A. Verbal—Say the name of the mode or an equivalent name, i.e., RDraw, Free Draw, Text, Edit, Recog, Lasso, etc., and the mode is engaged.
B. Draw an object—Draw an object that equals a Mode and the mode is activated.
C. A Mode can be invoked by a gesture line or object. A gesture line can be drawn in a computer environment to activate one or more modes. A gesture object that can invoke one or more modes can be dragged or otherwise presented in a computer environment and then activated by some user action or context.
D. Using rhythms to activate computer operations—The tapping of a rhythm on a touch screen or by pushing a key on a cell phone, keyboard, etc., or by using sound to detect a tap, e.g., taping on the case of device or using a camera to detect a rhythmic tap in free space can be used to activate a computer mode, action, operation, function or the like.

FIG. 68 illustrates a gesture method for removing the menu for “Place in VDACC object.” Placing objects in a VDACC object has proven to be a very useful and effective function in Blackspace. But one drawback is that the use of a VDACC object requires navigating through a menu (Info Canvas) looking for a desired entry. In FIG. 68 an arrow 132 is drawn to enclose a space 134. When the arrow 132 is activated by touching the white arrowhead 133 or its equivalent, anything inside that arrow's space 134 will be placed into a VDACC or its equivalent.

The embodiment illustrated in FIGS. 69 and 70, enables a user to draw a single graphic that does the following things:
(a) It selects the objects to be contained in or managed by a VDACC object.
(b) It defines the visual size and shape of the VDACC object.
(c) It supports further modification to the type of VDACC object to be created.
   A graphic that can be drawn to accomplish these tasks is a rectangular arrow 135 that points to its own tail. Not shown, this free drawn object is recognized by the software and is turned into a recognized arrow with a white arrowhead. Click on the white arrowhead to place all of the objects, PICTURE 1, 2, 3, and 4, impinged by this drawn graphic, into a VDACC object.

FIG. 69 illustrates a “place in VDACC object” line about a composite photo.

FIG. 70 illustrates drawing a “clip group” for objects appearing outside a drawn “Place in VDACC object” arrow. A “Place in VDACC object” arrow 136 has been drawn around three pictures 137 and accompanying text. Below the perimeter of this arrow 136 is another drawn arrow 138 that appends the graphical items 139 that lie outside the boundary of the first drawn “Place in VDACC object” arrow to the VDACC object that will be created by the drawing of said first arrow 136. The items impinged by the drawing of the second arrow 139 are clipped into the VDACC object created by the drawing of the first arrow 136. The size and dimensions of the resulting VDACC object are determined by the drawing of the first arrow 136. The second arrow tells the software to take the graphics 139 impinged by the second arrow 138 and clip them into the VDACC object created by the first arrow 136.

A place in VDACC object arrow may be modified, as shown in FIG. 71. The modifier arrow 141 makes the VDACC object, that is created by the drawing of the first arrow 140, invisible. So by drawing two graphics a user can create a VDACC object of a specific size, place a group of objects in it and make the VDACC object invisible. Click on either white arrowhead 142A or 142B and these operations are completed.

Removing Flip menus. Below are various methods of removing the menus (IVDACC objects) for flipping pictures and replacing them with gesture procedures. The embodiments below enable the flipping of any graphic object (i.e., all recognized objects), free drawn lines, pictures and even animations and videos.

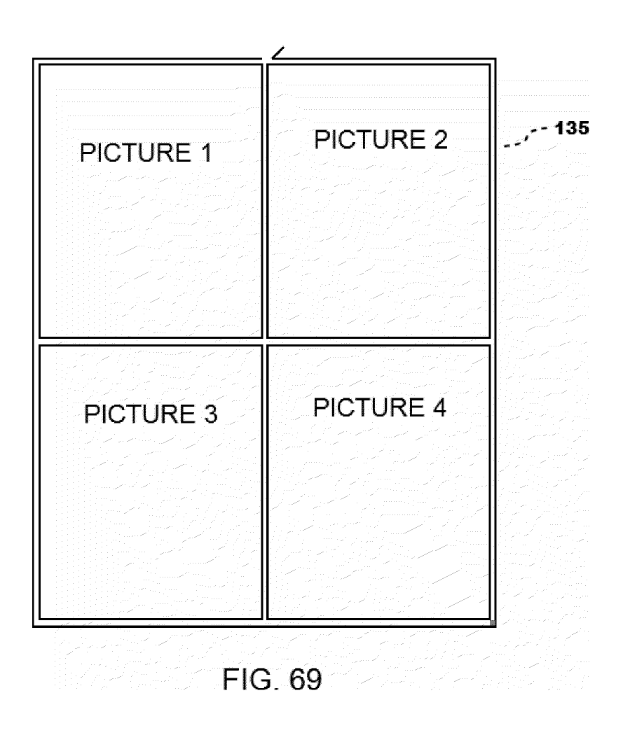

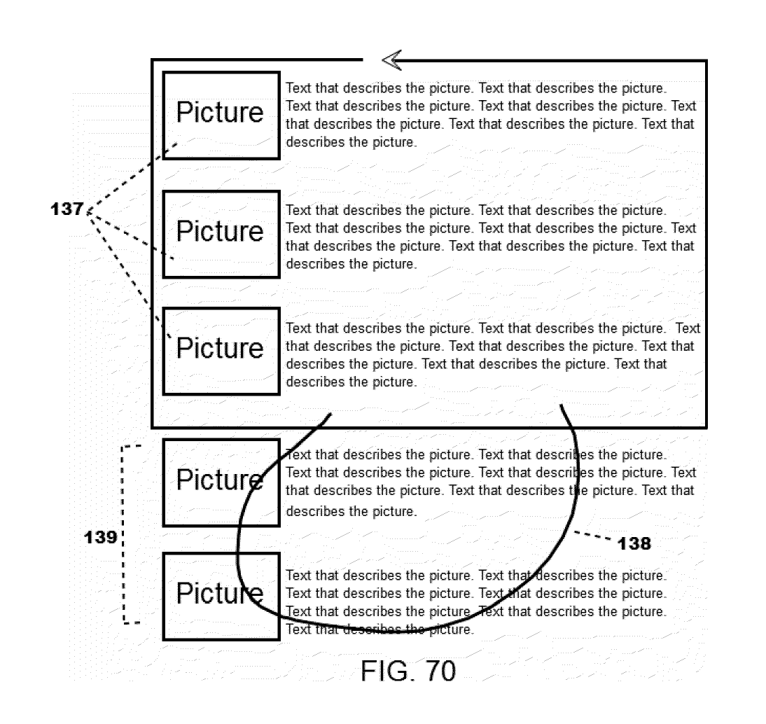

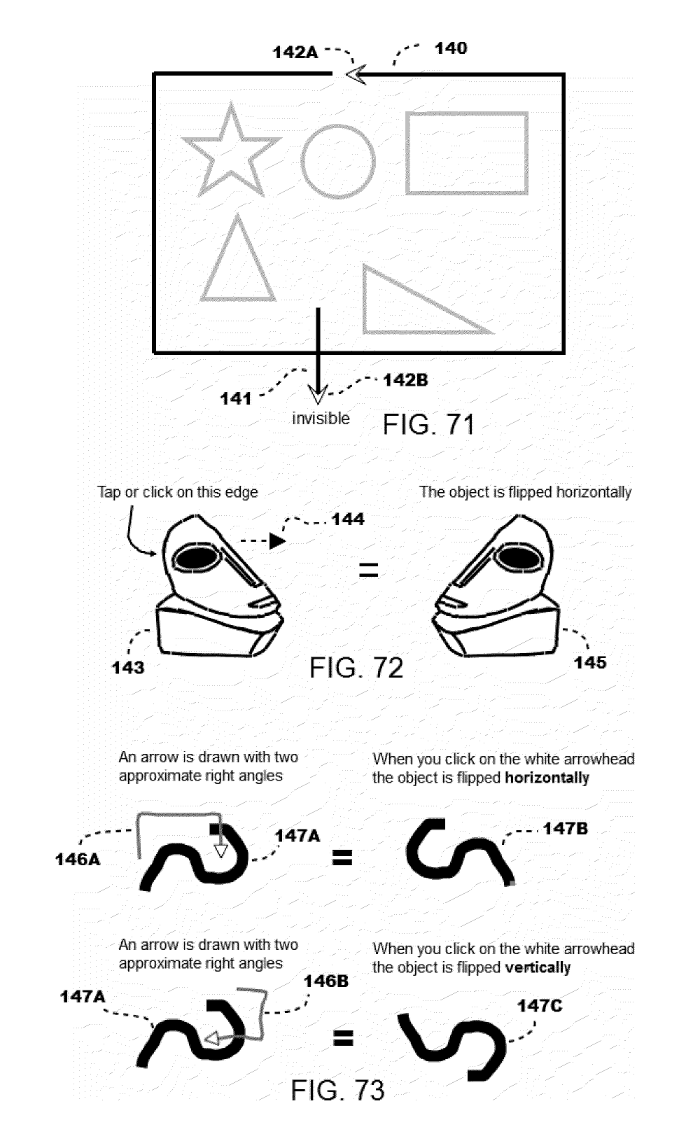

Referring to FIG. 72, a tap and drag is used to flip a picture. Tap or click on an edge of a graphic 143 and then within a specified time period, like 1 second, drag in the direction 144 that one wishes to flip the object. This action results in a horizontal flip 145 of object 143.

Referring to FIG. 73, this shows using a drawn arrow to invoke a flip horizontal or flip vertical action. Regarding a horizontal flip, an arrow 146A has been drawn to impinge an object. Upon the activation of the arrow 146A, the object 147A is flipped horizontally as shown as 147B. The shape of the drawn arrow determines the angle of the flip. Since the arrow 146A was drawn horizontally, it causes a horizontal flip for the object 147A that it impinges. Contrariwise, arrow 146B is drawn in a vertical orientation to impinge object 147A. The result is to cause object 147A to be flipped vertically as object 147C.

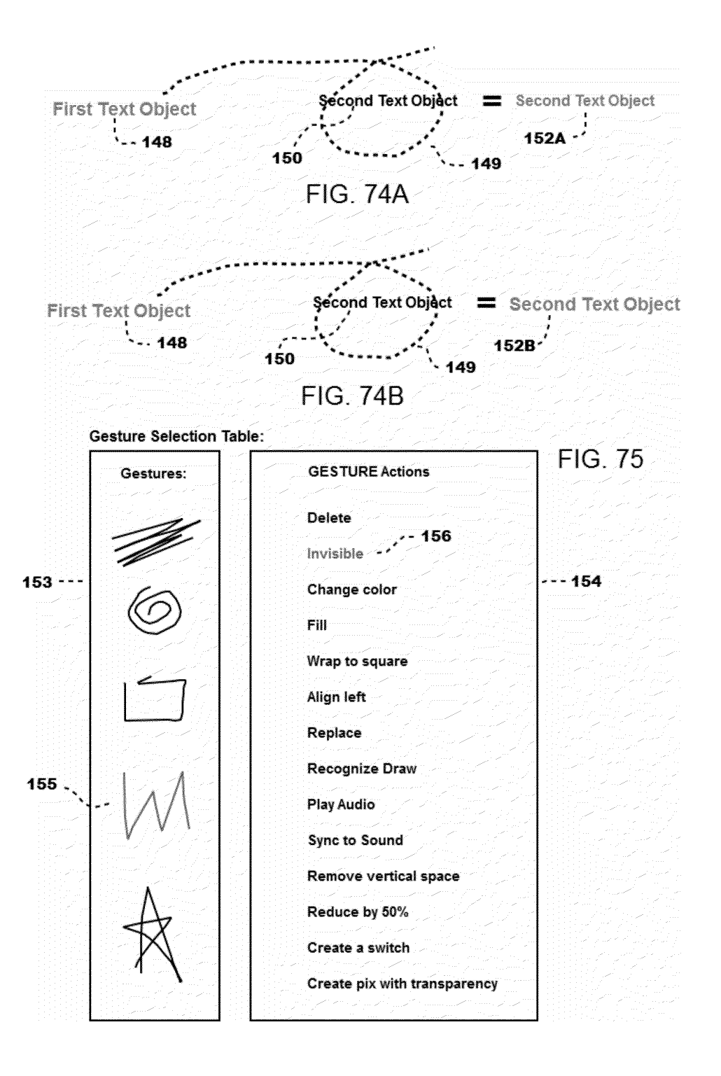

FIGS. 74A and 74B illustrate an example for text, but this model can be applied to virtually any object. The idea is that instead of using a recognized object, or a gesture object, one uses a non-gesture object and a context to program another object. Referring to FIG. 74A, text object 148 is dragged in a path defined by a recognizable shape 149, whereby text object 148 impinges a second text object 150. The result of this drag action is that the impinged text object 150 has one or more of its properties, behaviors or their equivalents, changed. In this example the color of object 150 is changed to match the object 148 that was dragged to impinge it, represented as object 152A. The recognizable shape 149 for the drag path of object 148 has an action (or its equivalent) programmed or assigned to it. Thus when any object is dragged in a path that defines this “programmed shape” 149, any object that is impinged by the dragged object will be programmed with whatever action, function or equivalent that is invoked by the recognized shape 149 in the dragged path. Referring now to FIG. 74B, an object 148 is dragged in a path that defines a recognized shape 149. In this case, this recognized shape has been programmed to invoke the action: “apply the color and size of a dragged object to the object(s) that it impinges.” Thus upon the dragging of object 148 to impinge object 150, the size and color of object 148 are changed to match object 148, as shown as object 152B. If one has a text object that is a custom color that you now want to apply to another text object that is of another color. Click on the first text object and drag it to make a gesture over one or more other text objects. The gesture (drag) of the first text object can cause the color of the text objects impinged by it to change to their color. For example, let's say you drag a first text object over a second text object and then move the first text object in a circle over the second object. This gesture shape could be programmed to evoke any one or more actions, like causing any object impinged by the dragged object to have its color match the object impinging it. Thus the dragging of this object in this shape could automatically change the color of any object it impinges. The context here is: (1) a text object of one color, (2) being dragged in a recognizable shape, (3) to impinge at least one other text object, (4) that is of a different color. The first text object is dragged in a definable pattern to impinge a second text object. This action does the following things in this example. It takes the color of the first text object and uses it to replace the color of the second text object. It does this without requiring the user to access an inkwell or eye dropper or enter any modes or utilize any other tools. The shape of the dragged path is a recognized object which equals the action: “change color to the dragged object's color.”

In another embodiment of this idea a first object can be dragged in the shape of a letter or character in a language, like an “m” or “o” or “c”. This gesture shape would be recognized by the software and would call forth a function, action, operation, object property, behavior (“object element”). This “object element” would program any object that the first object impinges with its dragged path. This dragged path could be after performing the recognized gesture, or before or during. The idea here is that an object itself is dragged to create a recognized shape that, when recognized by the software, calls forth an “object element.”

FIG. 75 illustrates another approach to programming gesture objects. This is to supply users with a simple table that they would use to pick and choose from to select the type of gesture and the result of the gesture. As an alternate, users could create their own tables—selecting or drawing the type of gesture object they wish for the left part of the table and typing or otherwise denoting a list of actions that are important to them for the right part of the table. Then the user would select a desired gesture object (it could turn green to indicate it has been selected) and then select one or more desired actions on the right side of the table.

Referring to FIG. 75, a gesture object 155 has been selected in the left table 153 and an action “invisible” 156 has been selected in the right table 154. Both selections are green to indicate they have been selected.

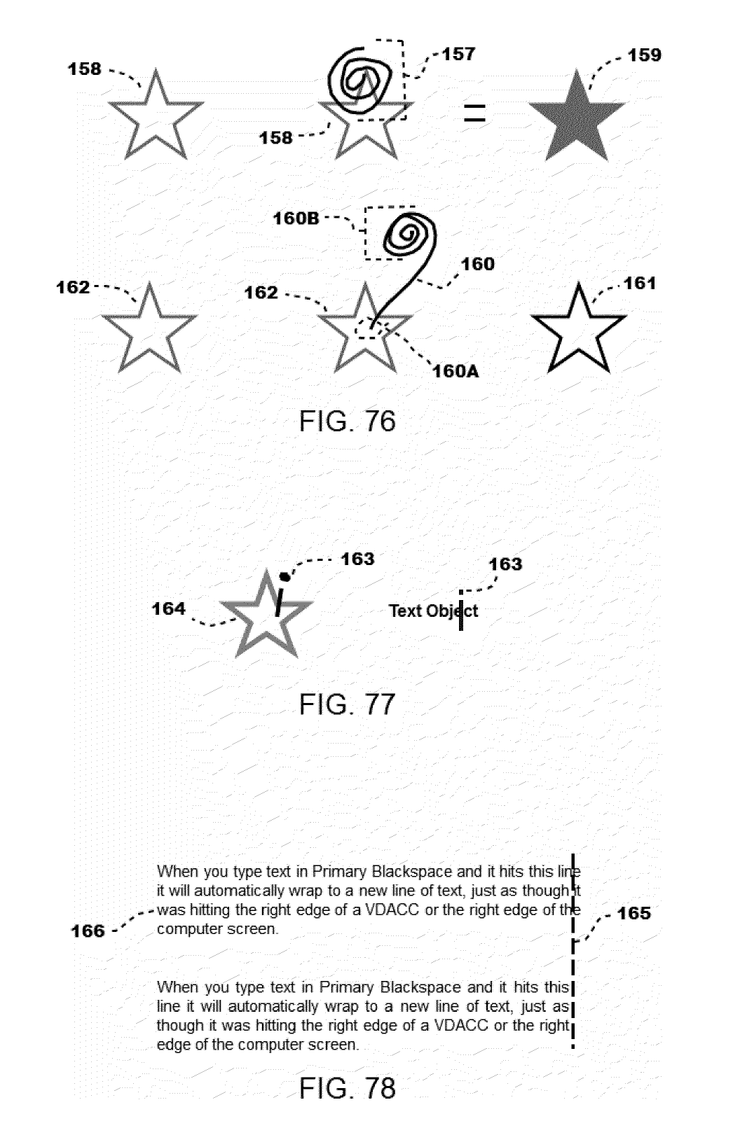

Filling objects and changing their line color. This removes the need for Fill menus (IVDACC objects). This idea utilizes a gesture that is much like what you would do to paint something. Here's how this works. Referring to FIG. 76, a color in an inkwell has been selected (not shown). A mouse, finger, pen or the like is used to create a pattern 157 over an object 158, including any graphic, video, picture, diagram, illustration, chart, text, and the like. This circular motion 157 feels like painting on something, like filling it in with brush strokes. There are many ways of invoking this: (1) with a mouse float after selecting a color, (2) with a drawn line after selecting a color, (3) with a hand gesture in the air—recognized by a camera device, etc. One way to utilize the inputted line 157 is to have a programmed gesture object (e.g., a line) that has been programmed with the action “fill.” A group of such gesture objects could comprise one's personal objects that would have the mode that created them built into their object definition. So selecting any of these personal objects (e.g. from a personal toolbox) will automatically engage the required mode that is necessary to input the object, e.g., by drawing or gesturing. In other words, if for instance, a gesture line is chosen from a collection of personal objects or its equivalent, the needed draw mode would automatically be engaged to permit the drawing of the gesture line. Utilizing this approach, one would select a “fill” gesture line from a tool box or other appropriate source and input a gesture as shown in FIG. 76. Note: the difference between the “fill” and “line color” gesture is only in where the gesture is inputted. Regarding the “fill” gesture 157 of FIG. 76, the gesture is inputted to impinge an object 158 to cause a change in the fill for that object shown as object 159. In this case the “swirl” 157 of the gesture 157 intersects the object 158. In the case of a line color change, gesture 160 is inputted such that the gesture 160 is started in a location that intersects the object 160A, but the recognized part of the gesture (the swirl) 160B is inputted outside the perimeter of the object. There are undoubtedly many approaches to be created for this. The ideas above are intended as illustrations only.

Removing the Invisible menu.—Referring to FIG. 77, a verbal command—“invisible” could be invoked to make any object invisible. An alternate to this approach would be to draw an “i′ 163 over the object you wish to make invisible, like a star 164. The “i” would be a letter that is recognized by the software. The advantage is that this letter object can be hand draw in a relatively large size, so it's easy to see and to draw and then when it's recognized, the image that is impinged by this hand drawn letter is made invisible. After activating its function, the letter would disappear from view. As an alternate one could program a gesture line to invoke the action invisible. One could create or recall an object, make it invisible, then draw a Context Stroke to impinge the invisible object (draw through the space where the invisible object is sitting). Then an Action Stroke would be inputted to impinge the same invisible object. Then a Gesture Object Stroke would be inputted and made to point to the gesture object for which one wishes to invoke the action “invisible.”

Removing the need for the “wrap to edge” menu item for text. This is a highly used action, so more than one alternate to an IVDACC object makes good sense. A replacement for the “wrap to edge” menu or IVDACC menu object is illustrated in FIG. 78. Here a user draws a vertical gesture line 165, programmed with the function: “wrap to edge,” in a computer environment. Then they type text 166, such that when the text collides with this line 165, the text 166 will wrap to a new line of text. This wrap to edge line 165 is a gesture line that invokes the action “wrap to edge” when it is impinged by the typing or dragging of a text object. NOTE: This gesture line 165 works for existing text. For existing text, it is first selected, then said gesture line 165 is drawn such that it either intersects the existing text or that is to the right or left of the existing text. It is important to note that the gesture line 165 does not have to be drawn to intersect existing text. If this were a requirement, then a user could never make the wrap width wider than it already is for a text object. So for a selected existing text object that has had a gesture line drawn to its right or left, the software looks to the right or left of the text object for a substantially vertical gesture line 165. If the software finds a vertical gesture line anywhere to the right or left of the text and that line impinges a horizontal plane defined by the selected text object, then the software will enact the “wrap to text” function for that text object. NOTE for a selected existing text object, if a non-gesture line is drawn after a verbal command “wrap to text” has been inputted to the software system, the software, upon finding a drawn line that impinges the horizontal plane of the selected text object, will enact the function “wrap to text” for that selected text object.

Vocal command. Wrap to edge can be invoked by a verbal utterance, e.g., “wrap to edge.” A vocal command is only part of the solution here, because if one selects text and says: “wrap to edge”, the text has to have something to wrap to. So if the text is in a VDACC object or typed against the right side of one's computer monitor, where the impinging of the monitor's edge by the text can cause “wrap to edge,” a vocal utterance can be a fast way of invoking this feature for the text object. But if a text object is not situated such that it can wrap to an “edge” of something, then a vocal utterance activating this “wrap to edge” will not be effective. So in these cases one needs to be able to draw a vertical line in or near the text object to tell the text object where to wrap to. This, of course, is only for existing text objects. Otherwise, using the “wrap to edge” line described in FIG. 78 is a good solution for newly typed text. For existing text, selecting the text, drawing a vertical line either through the text or to its right or left, and then saying “wrap to edge” or its equivalent would be quite effective. In this just described context, upon receiving this verbal command, the software would recognize the vocal command,e.g., “wrap to edge” and then look for a vertical line that is some minimum length (i.e., one half inch long) and which impinges a text object or its horizontal plane. If such a line is found the “wrap to edge” function would be enacted for the selected text object.

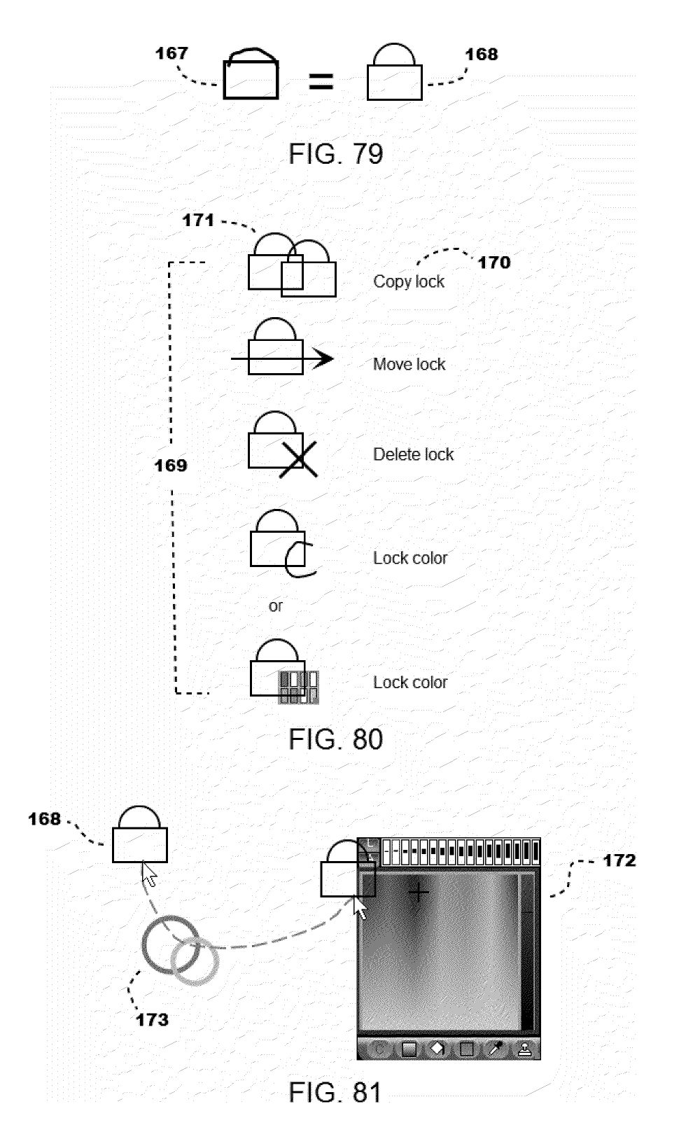

Removing the IVDACC objects for lock functions, such as move lock, copy lock, delete lock, etc. Referring to FIG. 79, a method is disclosed for distinguishing free drawn user inputs used to create a folder from free drawn user inputs used to create a lock object. Currently drawing an arch over the left, center or right top edge of a rectangle results in the software's recognition of a folder. A modification to this recognition software provides that any rectangle that is impinged by a drawn arch that extends to within 15% of its left and right edges 167 will not be recognized as a folder. Then drawing this will cause the software to recognize a lock object 168 which can be used to activate any lock mode.

FIG. 80 shows a list of different ways to utilize the Lock recognized object.

a. Accessing a List of Choices
Draw a recognized lock object (shown in FIG. 79 as object 167), and once it is recognized (FIG. 79, object 168), click on it and the software will present a list (FIG. 80, a list 169) of the available lock features in the software. These features can be presented as either text objects, FIG. 80, text objects 170, or graphical objects, FIG. 80, objects 171. Then select the desired lock object or text object.

Activating a Default Lock Choice.
With this idea the user sets one of the available lock choices as a default that will be activated when the user draws a “lock object” and then drags that object to impinge an object for which they wish to convey the default action for lock. One way to set one of the choices in the FIG. 80, the list 171, would be to type the word: “default” and then drag the text object “default” to impinge the desired default lock object in the list 171. Another way would be to say: “default” and then touch the desired default lock object in the 171 list. Possible lock actions include: move lock, lock color, delete lock, and the like.

FIG. 81 shows another way to invoke Lock Color. A lock object 168 is dragged to impinge two colored circle objects 173 for which a user wants to lock the color. Then the lock 168 is dragged to intersect an inkwell 172. This action locks the color of these two impinged objects.

Verbal commands. The function “lock” is a very good candidate for verbal commands. Such verbal commands could include: “lock color,”, “move lock”, “delete lock,” “copy lock,” etc. Said verbal commands would be implemented by select one or more objects and then inputted the desired “lock” verbal command.

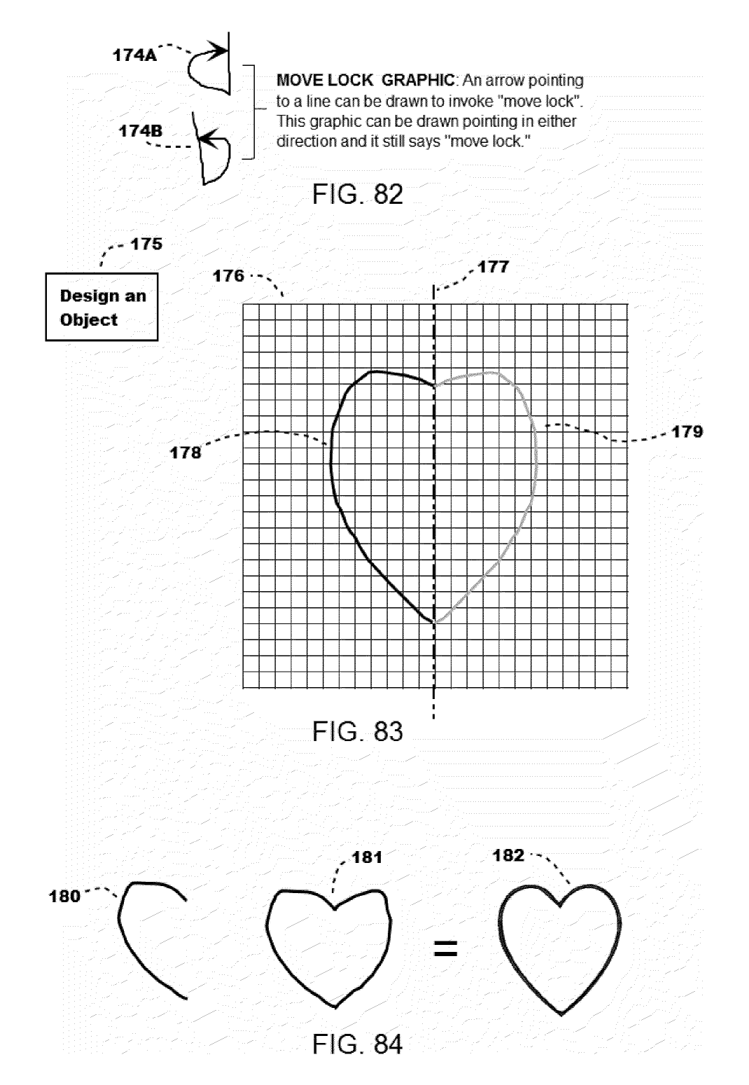

Unique recognized objects. These would include hand drawn objects that would be recognized by the software. FIG. 82 shows an example of such an object to that could be used to invoke “move lock.” Objects 174A and 174B are arrows that are drawn pointing to their own shaft where the point of the arrow is within a short distance to the origin of the shaft. This distance is user-definable.

Creating user-drawn recognized objects. This section describes a method to “teach” Blackspace how to recognize new hand drawn objects. This enables users to create new recognized objects, like a heart or other types of geometric objects. These objects need to be easy to draw repeatedly and have the software be able to recognize them, so scribbles or complex objects with curves are not good candidates for this approach. What are good candidates are simple objects where the right and left halves of the object are exact or nearly exact matches.

This carries with it two advantages: (1) the user only has to draw the left half of the object, and (2) the user can immediately see if their hand drawn object has been recognized by the software. Here's how this works. Referring to FIG. 83, a grid appears onscreen when a user selects a mode, which can carry any name; for example, “design an object.” So for instance, a user activates a switch labeled “design an object” 175 or types this text or its equivalent in Blackspace, activates it and a grid 176 appears. This grid has a vertical line 177 running down its center. The grid is comprised of relatively small grid squares, which are user-adjustable. This smaller squares (or rectangles) are for accuracy of drawing and accuracy of computer analysis.

A user draws or gestures the left half of the object they want to create. In this case it's a heart shape 178. Then when they lift up their mouse or finger (do an up-click or its equivalent) the software analyzes the left half of the user created object 178 and then automatically draws the second half of the object 179 on the right side of the grid. The user can see immediately if the software has properly recognized what they drew by comparing what they created on the left side of the grid to what the computer created on the right side of the grid. If the computer's results are not satisfactory, the user will probably need to simplify their drawing or draw it more accurately. If the other half 179 is close enough, then the user enters one final input. This could be in the form of a verbal command, like, “save object” or “create new object,” etc. Then when the user activates a recognize draw mode and draws their new object, e.g., the heart object of FIG. 83, the computer creates a perfect computer rendered heart object from the user's free drawn object. And the user would only need to draw half of the object, as shown in FIG. 83, object 178.

For these new objects to have value to a user as operational tools, whatever is user-created needs to be repeatable. The idea is to give a user unique and familiar recognized objects to use as tools in the computer environment, but that can be inputted, e.g. drawn or gestured, over and over with the same computer recognition result. So these new objects need to have a high degree of recognition accuracy.

FIG. 84 shows a half heart 180 that has been inputted into a computer system via drawing, gesturing, computer generated input, and the like. The computer analyzes the half heart input 181 and then if the half heart is successfully recognized by the software as a heart object, the software creates a computer generated heart object graphic 182.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A method for controlling a computer operation comprising the following operations in no particular order:
displaying, using a display device, at least one graphic object;
inputting at least one gesture object
impinging said graphic object with said gesture object
generating an instruction for invoking a computer operation to process said graphic object, based on a relationship between said graphic gesture and said graphic object.

2. The method of claim 1, wherein said graphic object is wrapped by a text object, the method further comprising:
analyzing at least one vertical space associated with said graphic object; and
reducing a height of the said graphic object if said graphic object impinges a line of said text object by less than a predetermined percentage of a height of said line of said text object, to prevent said line of said text object impinged by said graphic object from wrapping.

3. The method of claim 1, wherein the graphic gesture is a line.

4. The method of claim 3, wherein the line is around an object wrapped by a text object, and wherein said instruction generated by the arrow logic module is rewrapping the text by taking the line as a border.

5. The method of claim 4, wherein said instruction generated by the arrow logic module rescales at least one character space of the rewrapped text.

6. The method of claim 1 further comprising dragging said graphic object along a path that is substantially in the shape of a recognized gesture, to invoke at least one computer operation associated with said recognized gesture.

7. The method of claim 1, wherein said graphic gesture object is a line, the method further comprising the step of generating a specifier having a computer operation associated therewith, said specifier impinging said graphic gesture object, thereby invoking said computer operation.

8. The method of claim 7, wherein the specifier associates therewith an action applied to the top margin of a text object.

9. The method of claim 7, wherein the specifier associates therewith an action applied to the bottom margin of a text object.

10. The method of claim 1, wherein said computer operation is affecting a top margin of a text object.

11. The method of claim 1, wherein said computer operation is affecting a bottom margin of a text object.

12. The method of claim 1, wherein said at least one graphic gesture object is a line, and an action associated with the inputting of said line is setting a clipping boundary of a graphic object.

13. The method of claim 12, wherein said graphic object associated with said clipping boundary is a text object.

14. The method of claim 13, wherein said text object is a primary text object that can manage other objects.

15. The method of claim 1, further comprising impinging said graphic gesture object with a second graphic gesture object to modify said computer operation associated with said graphic gesture object.

16. The method of claim 15, the second graphic gesture object having a computer operation associated therewith, wherein said second graphic gesture object's computer operation modifies the computer operation associated with said graphic gesture object.

17. The method of claim 16, wherein the graphic gesture having a computer operation associated therewith, wherein said graphic gesture's computer operation modifies the computer operation associated with said graphic gesture object.

18. The method of claim 1, further comprising impinging said graphic gesture object with a graphic gesture to modify said computer operation associated with said graphic gesture object.

19. The method of claim 1, wherein said graphic object owns at least one additional graphic object, and attributes of said additional graphic object change according to at least one attribute of said graphic object.

20. The method of claim 19, wherein said graphic object is a text object, and said additional graphic object is a picture, and said additional graphic object is moved and rescaled in accordance with said graphic object.

21. The method of claim 19 further comprising placing the said graphic object over any other graphic object to crop said any graphic object to create a cropped object.

22. The method of claim 1, wherein said graphic object is a text object, and said additional graphic object is a picture wrapped by said text object, said graphic gesture object having an action of modifying a border of the picture associated therewith.

23. The method of claim 1, wherein said graphic gesture object has a prevent action associated therewith.

24. The method of claim 23, wherein said prevent action prevents a graphic object, which a prevent gesture object impinges, from being assigned to other graphic gestures.

25. The method of claim 1, further comprising making a gesture using said graphic object to apply at least one of the following: property, behavior, action, function, operation, condition, process, procedure, status of said graphic object to a second graphic object.

26. A method for controlling a computer operation comprising the following operations in no particular order:
displaying, using a display device, at least one graphic object;
inputting at least one gesture object;
impinging said graphic object with said gesture object;
generating an instruction for invoking a computer operation to process said graphic object, based on a relationship between said graphic gesture and said graphic object;
further comprising dragging said graphic object in a path that substantially describes the shape of a graphic gesture, to cause at least one action to be invoked on graphic objects impinged by the dragging of said graphic object.

27. The method of claim 1, wherein a graphic gesture is performed in a recognized context to call forth action(s) associated with the graphic gesture.

28. The method of claim 1, wherein a graphic gesture is a line in a specific line style.

29. A method for controlling a computer operation comprising the following operations in no particular order:
displaying, using a display device, at least one graphic object;
inputting at least one gesture object;
impinging said gesture object with said graphic object;
invoking at least one operation of said gesture object; and
generating an instruction for invoking a computer operation to process said graphic object.

30. A method for controlling a computer operation comprising the following operations in no particular order:
displaying, using a display device, at least one graphic object, said graphic object having at least one defining property; and
dragging said graphic object in a path that substantially describes the shape of a recognized gesture, said dragging of said graphic object invoking of at least one operation of said recognized gesture according to said at least one property of said at least one graphic object.

31. The method of claim 1 further comprising dragging said graphic object along a path of a recognized shape, to invoke at least one computer operation associated with said recognized shape.
